(19) United States
(12) Patent Application Publication
(10) Pub. No.: US 2024/0062356 A1
(43) Pub. Date: Feb. 22, 2024

(54) DATA-DRIVEN PREDICTION AND IDENTIFICATION OF FAILURE MODES BASED ON WAFER-LEVEL ANALYSIS AND ROOT CAUSE ANALYSIS FOR SEMICONDUCTOR PROCESSING

(71) Applicant: ASML Netherlands B.V., Veldhoven (NL)

(72) Inventors: Huina XU, Los Altos, CA (US); Yana MATSUSHITA, Redwood City, CA (US); Tanbir HASAN, San Jose, CA (US); Ren-Jay KOU, Cupertino, CA (US); Namita Adrianus GOEL, San Jose, CA (US); Hongmei LI, San Jose, CA (US); Maxim PISARENCO, Son en Breugel (NL); Marleen KOOIMAN, Eindhoven (NL); Chrysostomos BATISTAKIS, Eindhoven (NL); Johannes ONVLEE, 's-Hertogenbosch (NL)

(73) Assignee: ASML Netherlands B.V., Veldhoven (NL)

(21) Appl. No.: 18/268,924

(22) PCT Filed: Dec. 9, 2021
(86) PCT No.: PCT/EP2021/084913

§ 371 Date: Jun. 21, 2023

Related U.S. Application Data
(60) Provisional application No. 63/159,389, filed on Mar. 10, 2021.
(60) Provisional application No. 63/128,764, filed on Dec. 21, 2020.

(51) Int. Cl. G06T 7/00

(52) U.S. Cl. CPC G06T 7/0004; G06T 2207/10061; G06T 2207/20021; G06T 2207/30148; G06T 2207/20081

(57) ABSTRACT

A method and apparatus for analyzing an input electron microscope image of a first area on a first wafer are disclosed. The method comprises obtaining a plurality of mode images from the input electron microscope image corresponding to a plurality of interpretable modes. The method further comprises evaluating the plurality of mode images, and determining, based on evaluation results, contributions from the plurality of interpretable modes to the input electron microscope image. The method also comprises predicting one or more characteristics in the first area on the first wafer based on the determined contributions. In some embodiments, a method and apparatus for performing an automatic root cause analysis based on an input electron microscope image of a wafer are also disclosed.

### CROSS-REFERENCE TO RELATED APPLICATIONS

This application claims priority of U.S. application Ser. 63/128,764 which was filed on 21 Dec. 2020, and U.S. application Ser. No. 63/159,389 which was filed on 10 Mar. 2021, which are incorporated herein in its entirety by reference.

### TECHNICAL FIELD

The embodiments provided herein relate to semiconductor manufacturing, and more particularly, related to failure analysis with respect to semiconductor wafers.

### BACKGROUND

In manufacturing processes of integrated circuits (ICs), unfinished or finished circuit components are inspected to ensure that they are manufactured according to design and are free of defects. Inspection systems utilizing optical microscopes or charged particle (e.g., electron) beam microscopes can be employed. For example, a charged particle (e.g., electron) beam microscope, such as a scanning electron microscope (SEM) or a transmission electron microscope (TEM), can serve as a practicable tool for inspecting IC components.

Critical dimensions of patterns or structures measured from SEM or TEM image can be used to detect defects of manufactured ICs. For example, shifts between patterns or edge placement variations can be helpful in controlling manufacturing processes as well as in determining defects. As the physical sizes of IC components continue to shrink, accuracy and yield in defect detection become more important.

Semiconductor microchip fabrication includes hundreds of steps. Root cause analysis is important because it helps to optimize the manufacture process by identifying the significant steps and study the causations of defects.

### SUMMARY

One aspect of the present disclosure is directed to a method of analyzing an input electron microscope image of a first area on a first wafer. The method comprises obtaining a plurality of mode images from the input electron microscope image corresponding to a plurality of interpretable modes. The method also comprises evaluating the plurality of mode images, and determining, based on evaluation results, contributions from the plurality of interpretable modes to the input electron microscope image. The method further comprises predicting one or more characteristics in the first area on the first wafer based on the determined contributions.

Another aspect of the present disclosure is directed to an apparatus for analyzing an input electron microscope image of a first area on a first wafer. The apparatus comprises a memory storing a set of instructions; and at least one processor configured to execute the set of instructions to cause the apparatus to perform: obtaining a plurality of mode images from the input electron microscope image corresponding to a plurality of interpretable modes, evaluating the plurality of mode images, determining, based on evaluation results, contributions from the plurality of interpretable modes to the input electron microscope image, and predicting one or more characteristics in the first area on the first wafer based on the determined contributions.

Yet another aspect of the present disclosure is directed to a non-transitory computer readable medium that stores a set of instructions that is executable by at least one processor of a computing device to cause the computing device to perform a method for facilitating inspection of a wafer. The method comprises obtaining a plurality of mode images from the input electron microscope image corresponding to a plurality of interpretable modes; evaluating the plurality of mode images; determining, based on evaluation results, contributions from the plurality of interpretable modes to the input electron microscope image; and predicting one or more characteristics in the first area on the first wafer based on the determined contributions.

Yet another aspect of the present disclosure is directed to a method of training a classifier model for classifying electron microscope images. The method comprises obtaining training electron microscope images of a plurality of wafers; obtaining label data of the training electron microscope images indicating a plurality of interpretable modes associated with each of the training electron microscope images; and training the classifier model based on the training electron microscope images and the label data.

Yet another aspect of the present disclosure is directed to an apparatus for training a classifier model for classifying electron microscope images. The apparatus comprises a memory storing a set of instructions; and at least one processor configured to execute the set of instructions to cause the apparatus to perform: obtaining training electron microscope images of a plurality of wafers; obtaining label data of the training electron microscope images indicating a plurality of interpretable modes associated with each of the training electron microscope images; and training the classifier model based on the training electron microscope images and the label data.

Yet another aspect of the present disclosure is directed to a non-transitory computer readable medium that stores a set of instructions that is executable by at least one processor of a computing device to cause the computing device to perform a method of training a classifier model for classifying electron microscope images. The method comprises obtaining training electron microscope images of a plurality of wafers; obtaining label data of the training electron microscope images indicating a plurality of interpretable modes associated with each of the training electron microscope images; and training the classifier model based on the training electron microscope images and the label data.

Yet another aspect of the present disclosure is directed to a method for an automatic root cause analysis based on an input electron microscope image of a wafer. The method comprises: obtaining input data associated with the input electron microscope image, the input data including a plurality of process features of the wafer; identifying a set of process features from the plurality of process features by applying a plurality of pre-trained decision tree models to the plurality of process features; and outputting a ranking result of the set of process features.

Yet another aspect of the present disclosure is directed to an apparatus for an automatic root cause analysis based on an input electron microscope image of a wafer. The apparatus comprises a memory storing a set of instructions; and at least one processor configured to execute the set of instructions to cause the apparatus to perform: obtaining input data associated with the input electron microscope image, the input data including a plurality of process features of the wafer; identifying a set of process features from the plurality of process features by applying a plurality of pre-trained decision tree models to the plurality of process features; and outputting a ranking result of the set of process features.

Yet another aspect of the present disclosure is directed to a non-transitory computer readable medium that stores a set of instructions that is executable by at least one processor of a computing device to cause the computing device to perform a method of training a classifier model for classifying electron microscope images. The method comprises: obtaining input data associated with the input electron microscope image, the input data including a plurality of process features of the wafer; identifying a set of process features from the plurality of process features by applying a plurality of pre-trained decision tree models to the plurality of process features; and outputting a ranking result of the set of process features.

Other advantages of the embodiments of the present disclosure will become apparent from the following description taken in conjunction with the accompanying drawings wherein are set forth, by way of illustration and example, certain embodiments of the present disclosure.

### BRIEF DESCRIPTION OF FIGURES

FIG. 1 is a schematic diagram illustrating an example electron beam inspection (EBI) system, consistent with some embodiments of the present disclosure.

FIG. 2 is a schematic diagram illustrating an example electron beam tool that can be a part of the electron beam inspection system of FIG. 1, consistent with some embodiments of the present disclosure.

FIG. 3 is a block diagram of an example wafer analyzing system associated with wafer analysis and defects prediction, consistent with some embodiments of the present disclosure.

FIG. 4A is an example of a set of training images obtained by a training image acquirer, in accordance with some embodiments of the present disclosure.

FIG. 4B is an example of a set of labeled images corresponding to the set of training images of FIG. 4A processed using an automatic method, in accordance with some embodiments of the present disclosure.

FIG. 5 is a process flowchart representing an example method for training a classifier model, consistent with some embodiments of the present disclosure.

FIG. 6 illustrates a diagram flow representing an example process for predicting categories of defects on a wafer, consistent with some embodiments of the present disclosure.

FIG. 7 illustrates a diagram visualizing a non-liner classifier model and a linearized model being applied to a plurality of scanning electron microscope (SEM) images decomposed into two interpretable modes, consistent with some embodiments of the present disclosure.

FIG. 8 illustrates examples of visualized prediction results obtained by performing process on input SEM images, in accordance with some embodiments of the present disclosure.

FIGS. 9A-9E further illustrate examples of visualized prediction results (e.g., as in bar charts) obtained by performing process as discussed in FIG. 6 on various input SEM images, in accordance with some embodiments of the present disclosure.

FIG. 10 illustrates an example of visualized prediction results obtained using a logistic classifier model, in accordance with some embodiments of the present disclosure.

FIG. 11A is a process flowchart representing an example method for predicting failure modes based on input SEM images, consistent with some embodiments of the present disclosure.

FIG. 11B illustrates a diagram visualizing clustering based on interpretable modes of a plurality of SEM images and mapping of the clustering results on a wafer, consistent with some embodiments of the present disclosure.

FIG. 11C is a process flowchart representing an example method for analyzing failure modes based on input SEM images of a plurality of areas on a wafer, consistent with some embodiments of the present disclosure.

FIG. 12 is a block diagram of an example system configured to perform root cause analysis based on feature ranking results obtained from predictive models, consistent with some embodiments of the present disclosure.

FIG. 13 illustrates an example of visualization of feature importance in accordance with feature ranking results, in accordance with some embodiments of the present disclosure.

FIG. 14 is a process flowchart representing an example method for performing an automatic root cause analysis, consistent with some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations. Instead, they are merely examples of apparatuses and methods consistent with aspects related to the disclosed embodiments as recited in the appended claims. For example, although some embodiments are described in the context of utilizing electron beams, the disclosure is not so limited. Other types of charged particle beams may be similarly applied. Furthermore, other imaging systems may be used, such as optical imaging, photo detection, x-ray detection, etc.

Making extremely small ICs is a complex, time-consuming, and expensive process, often involving hundreds of individual steps. Errors in even one step have the potential to result in defects in the finished IC rendering it useless. Thus, one goal of the manufacturing process is to avoid such defects to maximize the number of functional ICs made in the process, that is, to improve the overall yield of the process.

One component of improving yield is monitoring the chip making process to ensure that it is producing a sufficient number of functional integrated circuits. One way to monitor the process is to inspect the chip circuit structures at various stages of their formation. Inspection can be carried out using a scanning electron microscope (SEM).

In EUV lithography, stochastic printing failures become a major limiting factor of the process window, which are random, non-repeating, isolated defects, such as microbridges, locally broken lines, and missing or merging contacts. These defects can be detected post-factum using after-etch SEM images. In addition, prediction models can also be used to enable early prediction of after-etch defects based on an SEM image of a wafer after lithography, which can further allow early correction based on the prediction. Existing defect predictions are based on parameter-based approaches (e.g., such as MetroLER or Stochalis) or machine learning models. However, existing methods suffer from either low prediction accuracy, or not being able to provide information related to the cause(s) of the defects.

Embodiments of the present disclosure include training and applying a machine learning model for failure classification that can advantageously enable interpretability of the generated prediction. In the training phase, a set of interpretable modes (e.g., modes of interest) such as CD, shift, ellipticity, etc. is proposed by an expert or computed automatically, and a (e.g., deep learning) classifier is trained on these modes. In the prediction phase, a given SEM image is decomposed in the interpretable modes and the classifier is applied. A mathematical approximation (e.g., a weighted polynomial approximation) of the classifier is employed in order to decompose the prediction into contributions from individual interpretable modes. According to analysis on respective contributions of the modes, causes of failure can be identified, for example, possible causes being one or more of small CD, strong y-shift, ellipticity, blurry edges, and etc.

According to embodiments of the present disclosure, a machine learning model, such as a neural network model, is first trained based on SEM images of a specific type of features on after-etch wafers (e.g., contact hole areas or any other type of features) and the associated label data indicating respective coefficients of a plurality of interpretable modes that can be used to characterize the various categories of defects on the wafers. During a prediction phase, an input SEM image of a wafer after development can be decomposed into a plurality of mode images associated with a plurality of predefined interpretable modes (e.g., corresponding to different causes, types or otherwise categories of defects). The trained machine learning model can be used to evaluate the decomposed mode images. For example, respective coefficients associated with the interpretable modes can be used as input to the machine learning model, and output of the machine learning model can include evaluation results, e.g., indicating likelihood of existence of a corresponding interpretable mode in the input SEM image. Then a regression model can be used to determine contributions from respective interpretable modes. The contributions can be used to interpret possible causes of the defects. Although the present disclosure describes after-etch defect prediction based on SEM images of wafers after lithography, it will be understood to one skilled in the art that similar prediction processes can also be applied to other stages during semiconductor manufacturing processes. For example, SEM images of wafers after deposition or after performing chemical mechanical polishing (CMP) layer can also be applied to predict defects on metal contacts.

Relative dimensions of components in drawings may be exaggerated for clarity. Within the following description of drawings, the same or like reference numbers refer to the same or like components or entities, and only the differences with respect to the individual embodiments are described. As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

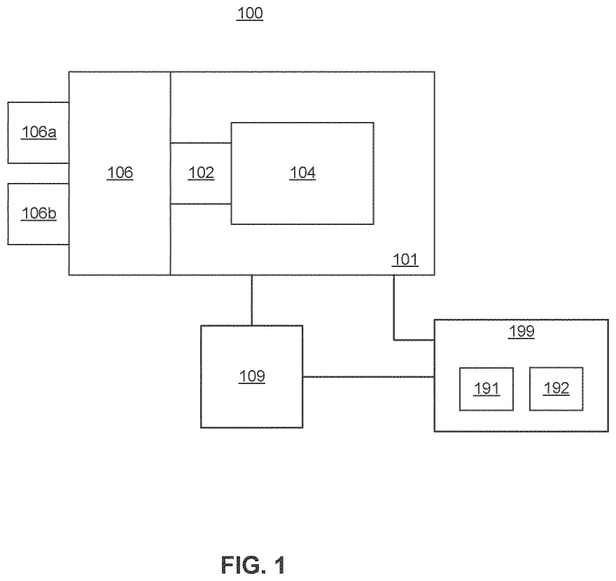

The present disclosure is not limited to any specific type of SEM equipment that can be used to for acquiring the images. FIG. 1 illustrates an exemplary electron beam inspection (EBI) system 100 consistent with some embodiments of the present disclosure. EBI system 100 may be used for imaging. As shown in FIG. 1, EBI system 100 includes a main chamber 101, a load/lock chamber 102, an electron beam tool 104, and an equipment front end module (EFEM) 106. Electron beam tool 104 is located within main chamber 101. EFEM 106 includes a first loading port 106a and a second loading port 106b. EFEM 106 may include additional loading port(s). First loading port 106a and second loading port 106b receive wafer front opening unified pods (FOUPs) that contain wafers (e.g., semiconductor wafers or wafers made of other material(s)) or samples to be inspected (wafers and samples may be used interchangeably). A “lot” is a plurality of wafers that may be loaded for processing as a batch.

One or more robotic arms (not shown) in EFEM 106 may transport the wafers to load/lock chamber 102. Load/lock chamber 102 is connected to a load/lock vacuum pump system (not shown) which removes gas molecules in load/lock chamber 102 to reach a first pressure below the atmospheric pressure. After reaching the first pressure, one or more robotic arms (not shown) may transport the wafer from load/lock chamber 102 to main chamber 101. Main chamber 101 is connected to a main chamber vacuum pump system (not shown) which removes gas molecules in main chamber 101 to reach a second pressure below the first pressure. After reaching the second pressure, the wafer is subject to inspection by electron beam tool 104. Electron beam tool 104 may be a single-beam system or a multi-beam system. It is appreciated that the system and method discussed herein can apply to both single-beam system and multi-beam system.

A controller 109 is electronically connected to electron beam tool 104. Controller 109 may be a computer configured to execute various controls of EBI system 100. Controller 109 may include processing circuitry configured to execute various signal and image processing functions. While controller 109 is shown in FIG. 1 as being outside of the structure that includes main chamber 101, load/lock chamber 102, and EFEM 106, it is appreciated that controller 109 may be a part of the structure. In some embodiments, controller 109 may include one or more processors coupled to one or more memories that store instructions that support various functions of controller 109.

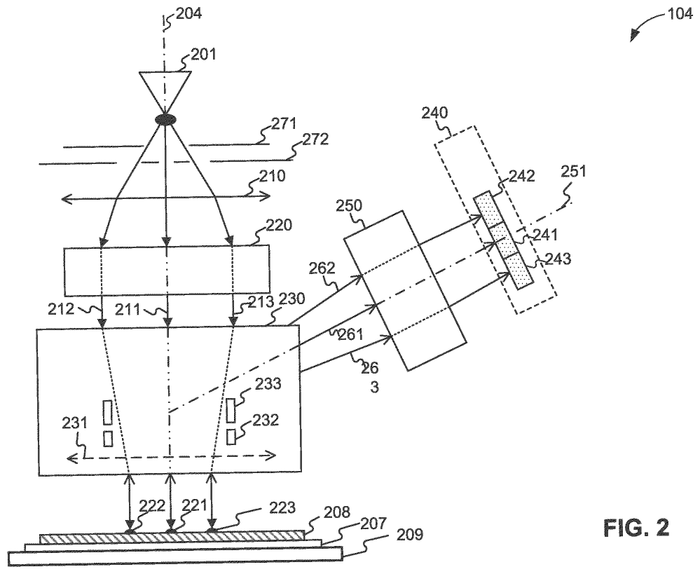

Reference is now made to FIG. 2, which is a schematic diagram illustrating an exemplary electron beam tool 104 including a multi-beam inspection tool that is part of EBI system 100 of FIG. 1, consistent with some embodiments of the present disclosure. It will be understood that the multi-beam electron beam tool is intended to be illustrative only and not to be limiting. The preset disclosure can also work with a single charged-particle beam imaging system. As shown in FIG. 2, electron beam tool 104 (also referred to herein as apparatus 104) comprises an electron source 201 configured to generate a primary electron beam, a Coulomb aperture plate (or “gun aperture plate”) 271 configured to reduce Coulomb effect, a condenser lens 210 configured to focus primary electron beam, a source conversion unit 220 configured to form primary beamlets (e.g., primary beamlets 211, 212, and 213), a primary projection system 230, a motorized stage 209, and a sample holder 207 supported by motorized stage 209 to hold a wafer 208 to be inspected. Electron beam tool 104 may further comprise a secondary projection system 250 and an electron detection device 240. Primary projection system 230 may comprise an objective lens 231. Electron detection device 240 may comprise a plurality of detection elements 241, 242, and 243. A beam separator 233 and a deflection scanning unit 232 may be positioned inside primary projection system 230.

Electron source 201, Coulomb aperture plate 271, condenser lens 210, source conversion unit 220, beam separator 233, deflection scanning unit 232, and primary projection system 230 may be aligned with a primary optical axis 204 of apparatus 104. Secondary projection system 250 and electron detection device 240 may be aligned with a secondary optical axis 251 of apparatus 104.

Controller 109 may be connected to various parts of EBI system 100 of FIG. 1, such as source conversion unit 220, electron detection device 240, primary projection system 230, or motorized stage 209. In some embodiments, as explained in further details below, controller 109 may perform various image and signal processing functions. Controller 109 may also generate various control signals to control operations of one or more components of the charged particle beam inspection system.

Deflection scanning unit 232, in operation, is configured to deflect primary beamlets 211, 212, and 213 to scan probe spots 221, 222, and 223 across individual scanning areas in a section of the surface of wafer 208. In response to incidence of primary beamlets 211, 212, and 213 or probe spots 221, 222, and 223 on wafer 208, electrons emerge from wafer 208 and generate three secondary electron beams 261, 262, and 263. Each of secondary electron beams 261, 262, and 263 typically comprise secondary electrons (having electron energy <50 eV) and backscattered electrons (having electron energy between 50 eV and the landing energy of primary beamlets 211, 212, and 213). Beam separator 233 is configured to deflect secondary electron beams 261, 262, and 263 towards secondary projection system 250. Secondary projection system 250 subsequently focuses secondary electron beams 261, 262, and 263 onto detection elements 241, 242, and 243 of electron detection device 240. Detection elements 241, 242, and 243 are arranged to detect corresponding secondary electron beams 261, 262, and 263 and generate corresponding signals which are sent to controller 109 or a signal processing system (not shown), e.g., to construct images of the corresponding scanned areas of wafer 208.

In some embodiments, detection elements 241, 242, and 243 detect corresponding secondary electron beams 261, 262, and 263, respectively, and generate corresponding intensity signal outputs (not shown) to an image processing system (e.g., controller 109). In some embodiments, each detection element 241, 242, and 243 may comprise one or more pixels. The intensity signal output of a detection element may be a sum of signals generated by all the pixels within the detection element.

In some embodiments, controller 109 may comprise an image processing system that includes an image acquirer (not shown) and a storage (not shown). The image acquirer may comprise one or more processors. For example, the image acquirer may comprise a computer, server, mainframe host, terminals, personal computer, any kind of mobile computing devices, and the like, or a combination thereof. The image acquirer may be communicatively coupled to electron detection device 240 of apparatus 104 through a medium such as an electrical conductor, optical fiber cable, portable storage media, IR, Bluetooth, internet, wireless network, wireless radio, among others, or a combination thereof. In some embodiments, the image acquirer may receive a signal from electron detection device 240 and may construct an image. The image acquirer may thus acquire images of wafer 208. The image acquirer may also perform various post-processing functions, such as generating contours, superimposing indicators on an acquired image, and the like. The image acquirer may be configured to perform adjustments of brightness and contrast, etc. of acquired images. In some embodiments, the storage may be a storage medium such as a hard disk, flash drive, cloud storage, random access memory (RAM), other types of computer readable memory, and the like. The storage may be coupled with the image acquirer and may be used for saving scanned raw image data as original images, and post-processed images.

In some embodiments, the image acquirer may acquire one or more images of a sample based on one or more imaging signals received from electron detection device 240. An imaging signal may correspond to a scanning operation for conducting charged particle imaging. An acquired image may be a single image comprising a plurality of imaging areas or may involve multiple images. The single image may be stored in the storage. The single image may be an original image that may be divided into a plurality of regions. Each of the regions may comprise one imaging area containing a feature of wafer 208. The acquired images may comprise multiple images of a single imaging area of wafer 208 sampled multiple times over a time sequence or may comprise multiple images of different imaging areas of wafer 208. The multiple images may be stored in the storage. In some embodiments, controller 109 may be configured to perform image processing steps with the multiple images of the same location of wafer 208.

In some embodiments, controller 109 may include measurement circuitries (e.g., analog-to-digital converters) to obtain a distribution of the detected secondary electrons. The electron distribution data collected during a detection time window, in combination with corresponding scan path data of each of primary beamlets 211, 212, and 213 incident on the wafer surface, can be used to reconstruct images of the wafer structures under inspection. The reconstructed images can be used to reveal various features of the internal or external structures of wafer 208, and thereby can be used to reveal any defects that may exist in the wafer.

In some embodiments, controller 109 may control motorized stage 209 to move wafer 208 during inspection of wafer 208. In some embodiments, controller 109 may enable motorized stage 209 to move wafer 208 in a direction continuously at a constant speed. In other embodiments, controller 109 may enable motorized stage 209 to change the speed of the movement of wafer 208 overtime depending on the steps of scanning process.

Although electron beam tool 104 as shown in FIG. 2 uses three primary electron beams, it is appreciated that electron beam tool 104 may use a single charged-particle beam imaging system (“single-beam system”), or a multiple charged-particle beam imaging system (“multi-beam system”) with two or more number of primary electron beams. The present disclosure does not limit the number of primary electron beams used in electron beam tool 104.

Referring back to FIG. 1, an analysis and prediction system 199 (“system 199”) may be in direct or indirect communication with controller 109. For example, system 199 can be a computer configured to communicate with controller 109, EBI system 100, any other apparatus, system, or database, wirelessly, remotely, or through a wired connection, among other communication methods. In some embodiments as discussed in the present disclosure, system 199 may be configured to receive instructions from a user through a user-interface, perform simulation and mathematical modeling of a process based on user input, predict a process outcome, and generate an image depicting the predicted process outcome

In some embodiments, system 199 may include one or more processors 191. A processor may be a generic or specific electronic device capable of manipulating or processing information. For example, the processor may include any combination of any number of a central processing unit (or “CPU”), a graphics processing unit (or “GPU”), an optical processor, a programmable logic controllers, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), and any type circuit capable of data processing. The processor may also be a virtual processor that includes one or more processors distributed across multiple machines or devices coupled via a network.

In some embodiments, system 199 may further include one or more memories 192. A memory may be a generic or specific electronic device capable of storing codes and data accessible by the processor (e.g., via a bus). For example, the memory may include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or any type of storage device. The codes may include an operating system (OS) and one or more application programs (or “apps”) for specific tasks. The memory may also be a virtual memory that includes one or more memories distributed across multiple machines or devices coupled via a network.

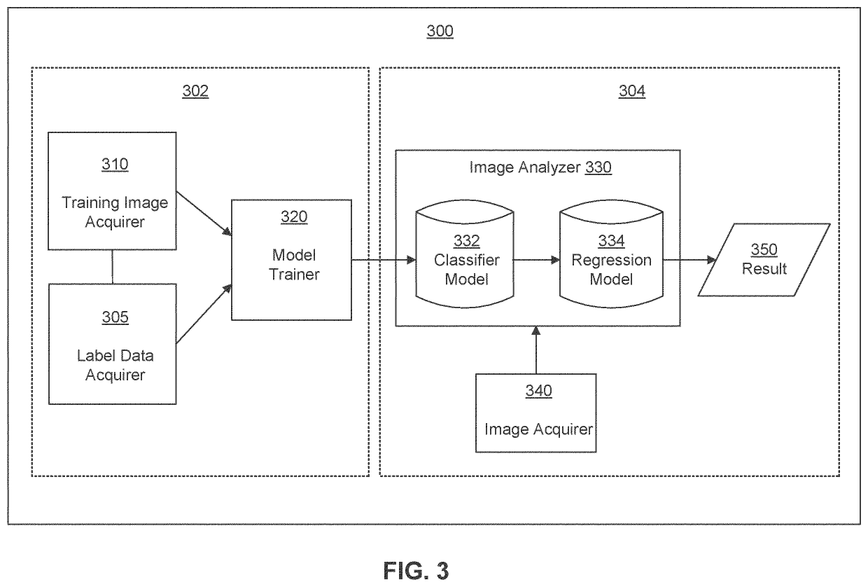

FIG. 3 is a block diagram of an example wafer analyzing system 300 associated with wafer analysis and defects prediction, consistent with some embodiments of the present disclosure. In some embodiments, wafer analyzing system 300 includes a training module 302 and an analyzing module 304. Training module 302 includes a training image acquirer 310, a label data acquirer 305, and a model trainer 320. Analyzing module 304 includes an image analyzer 330 including a classifier model 332 (e.g., generated by model trainer 320) and a regression model 334. Image analyzer 330 can process an image obtained by an image acquirer 340 to generate a result 350.

In some embodiments, wafer analyzing system 300 comprises one or more processors and memories. For example, wafer analyzing system 300 can comprise one or more computers, servers, mainframe hosts, terminals, personal computers, any kind of mobile computing devices, and the like, or combinations thereof. In some embodiments, training module 302 and analyzing module 304 are implemented on separate computing devices. In other embodiments, training module 302 and analyzing module 304 can be implemented on a same computing device. It is appreciated that wafer analyzing system 300 may include one or more components or modules that are integrated as parts of a charged-particle beam inspection system (e.g., electron beam inspection system 100 of FIG. 1). Wafer analyzing system 300 may also include one or more components or modules separate from and communicatively coupled to the charged-particle beam inspection system. In some embodiments, wafer analyzing system 300 may include one or more components (e.g., software modules) that can be implemented in controller 109 or system 199 as discussed herein.

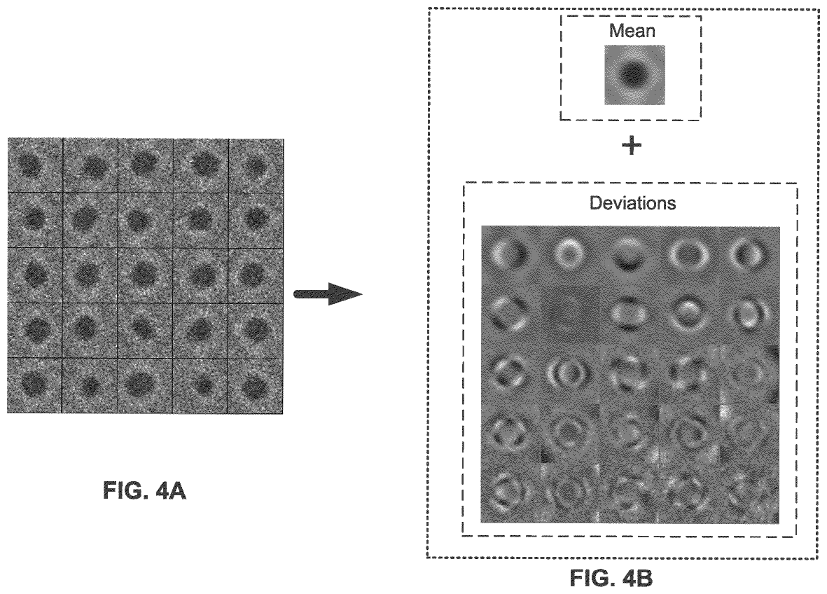

In some embodiments as shown in FIG. 3, training module 302 includes training image acquirer 310. Training image acquirer 310 may be configured to obtain training images (or training data), such as a plurality of SEM images of areas on wafers as shown in FIG. 4A. The acquired training images can be fed to model trainer 320 for training classifier model 332. In some embodiments, training image acquirer 310 can obtain the training images from a database, controller 109, system 199, or electron beam tool 104. For example, training image acquirer 310 may be the image acquirer of controller 109 as discussed herein. In some embodiments, a respective training image may correspond to an area on the wafer, including any type of 1D and 2D features, such as a single contact hole, multiple contact holes, one or more lines, a die, or an entire wafer. The present disclosure is not limited to any specific type of features on wafers. In some embodiments, the area of the wafer may be chosen based on a purpose of the analysis, such as to determine whether a contact hole fails or not, whether a line area is defective or not, or whether a part of the chip fails or not, and what type(s) of defects may contribute to such failure(s). In some embodiments, the training images may include SEM images of samples processed at different stages, such as after resist development, or after etching. In some embodiments, training data of the training images, such as pixel values corresponding to grayscale values, can be extracted from the training images to be used in the training process.

In some embodiments, training module 302 may include label data acquirer 305 configured to obtain label data associated with the training images obtained by training image acquirer 310. In some embodiments, each training image can be labeled by respective coefficients associated with a plurality of categories, such as multiple interpretable modes (or modes of interest). Each image may be labeled as a single category or a combination of multiple categories. In some embodiments, the interpretable modes may correspond to different categories of features, e.g., defects (or causes of failure), on the wafer. Some examples of the features or defects may include small critical dimension (CD), shift along a certain direction, ellipticity, blurry edges, printed contact hole, missing contact hole, bridging contact hole, etc. In some embodiments, the label data can be determined by an expert based on his or her prior knowledge. In some embodiments, the label data can be computed using an automatic program, such as principal component analysis (PCA) or singular value decomposition (SVD) method or any other suitable process that is well known in the art.

In some embodiments, model trainer 320 of training module 302 can train classifier model 332 based on the training images and the corresponding label data. In some embodiments, classifier model 332 can be a logistic regression model, a machine learning model such as a support vector machine, or a deep neural network (such as a convolutional neural network), or any other model suitable for predicting classification. In some embodiments, classifier model 332 can be used to predict whether each of one or more categories, as associated with one or more interpretable modes, exists in the corresponding SEM image. In some embodiments, the training results obtained by model trainer 320 include optimized weights for classifier model 332, as described in greater detail below.

FIG. 4A is an example of a set of training images obtained by training image acquirer 310, in accordance with some embodiments of the present disclosure. For example, as shown in FIG. 4A, the training images include SEM images of contact holes associated with different features or defects. The training images may correspond to contact holes at the same or different locations on the wafers.

FIG. 4B is an example of a set of labeled images corresponding to the set of training images of FIG. 4A processed using an automatic method, such as PCA, in accordance with some embodiments of the present disclosure. The labeled images correspond to different interpretable modes. In some embodiments, PCA is applied to the set of training images to determine respective coefficients associated with the principal components (e.g., corresponding to the interpretable modes). In some embodiments, as shown in FIG. 4B, a mean of the set of training images is first determined. Then, deviations of respective training images from the mean are calculated to determine coefficients of the principal components respectively. The obtained coefficients associated with the principal components can characterize respective features or defects as label data associated with the corresponding training images.

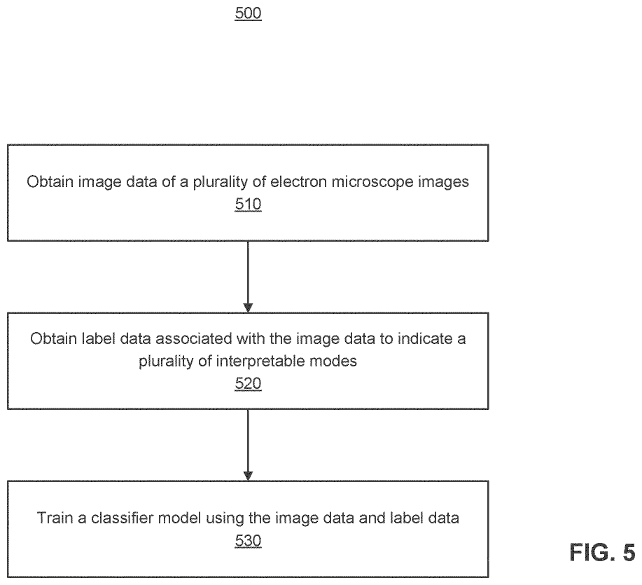

FIG. 5 is a process flowchart representing an example method 500 for training a classifier model (e.g., classifier model 332), consistent with some embodiments of the present disclosure. In some embodiments, one or more steps are performed by one or more components of system 300 in FIG. 3 (e.g., training module 302), controller 109, or system 199 in FIG. 1.

As shown in FIG. 5, in step 510, image data of a plurality of training images can be obtained. In some embodiments, the training images may be electron microscope images, such as SEM images as shown in FIG. 4A. The training images may be obtained by training image acquirer 310 in FIG. 3, or controller 109 or system 199 in FIG. 1. The training images may be obtained from controller 109, system 199, or electron beam tool 104 in FIG. 1, or any other suitable database. In some embodiments, the image data of the plurality of training images can include pixel values of each training image.

In step 520, label data associated with the training images can be obtained. In some embodiments, the label data may be obtained by label data acquirer 305 in FIG. 3, or controller 109 or system 199 in FIG. 1. In some embodiments, label data acquirer 305 may process the training images obtained in step 510 using an automatic procedure such as PCA/SVD (e.g., as shown in FIG. 4B). In some embodiments, the training images can be analyzed and labeled by an expert based on prior knowledge. In some other embodiments, the training images can be labeled by an automated process that is implemented as a software program. In some embodiments, the label data can include coefficients associated with respective interpretable modes that can characterize features or defects associated with each training image, such as small critical dimension (CD), shift along a certain direction, ellipticity, blurry edges, printed contact hole, missing contact hole, bridging contact hole, etc.

In step 530, a classifier model (e.g., classifier model 332 in FIG. 3) can be trained (e.g., via model trainer 320 in FIG. 3) based on training images and the associated label data. In some embodiments, the classifier model can include any model suitable for classification, such as a logistic regression model, a support vector machine, or a deep neural network. Any suitable training procedure can be used to optimize the weights of the classifier model.

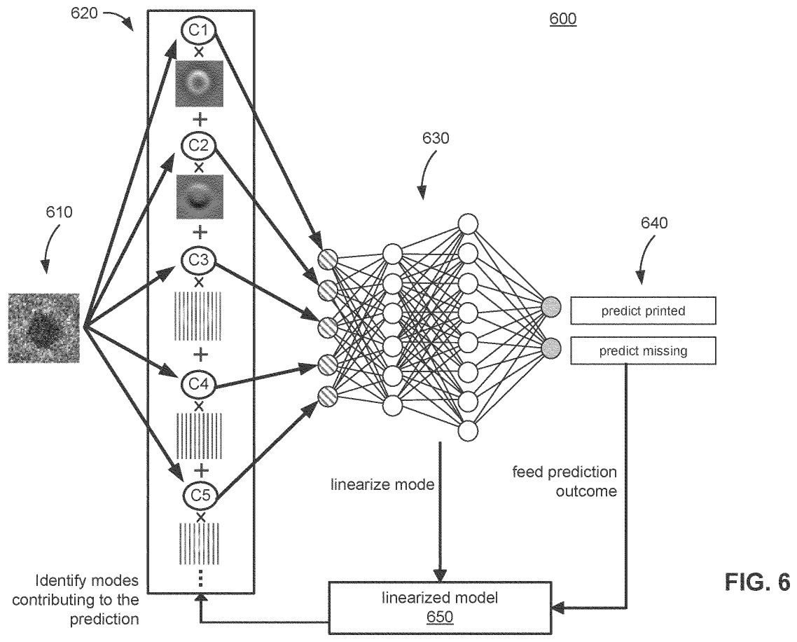

Referring back to FIG. 3, in some embodiments, analyzing module 304 of wafer analyzing system 300 includes image acquirer 340 configured to obtain an input microscope image (e.g., an input SEM image) of an area on the wafer for defect analysis (e.g., predicting a cause of failure associated with a wafer). In some embodiments, image acquirer 340 can obtain the input image from electron beam tool 104, controller 109, or system 199 as shown in FIG. 1. For example, image acquirer 340 may be the image acquirer of controller 109 as discussed herein. In some embodiments, the input image may correspond to an area on the wafer that requires defect prediction, such as a single contact hole, multiple contact holes, one or more lines, a die, or an entire wafer. In some embodiments, the input image may be an SEM image of a wafer taken at different stages during semiconductor processing, such as after development in lithography, or after etching. For example, classifier model 332 may be trained using training images of wafers processed after etching and the associated label data as discussed herein, while classifier model 332 can be used to predict categories of defects an input image of a wafer after development in lithography for early defects detection/prediction. For example, coefficients associated with respective interpretable modes obtained from decomposing the input image can be fed as input into classifier model 332, to obtain output as evaluation results associated with respective interpretable modes (e.g., evaluation results 640 in FIG. 6 indicating whether a certain interpretable mode exists or not). Further, the training images (e.g., the SEM images of after-etch wafers) used for training classifier model 332 may correspond to different areas on wafers than the area in an input SEM image for prediction. For example, classifier model 332 can be trained using training images capturing contact holes on various locations on one or more wafers. After training, such classifier model 332 can be used to predict categories of defects associated with a certain contact hole that is located at the same or different location from any of those included in the training images.

In some embodiments, analyzing module 304 includes image analyzer 330 configured to analyze the input image. In some embodiments, analyzing module 304 can decompose the input image into a plurality of interpretable mode images corresponding to different categories of defects and obtain coefficients associated with respective interpretable modes for characterizing the input image. The input image may be decomposed using PCA or any other suitable method that is well known in the art.

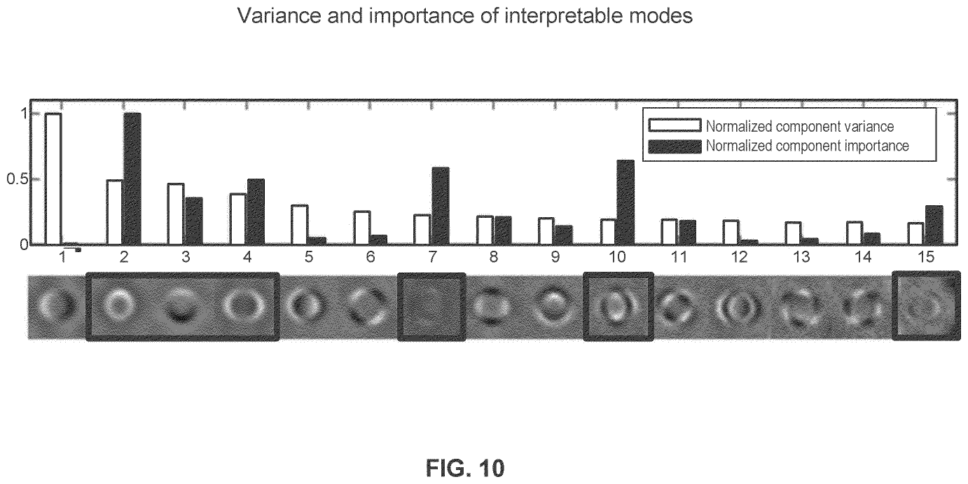

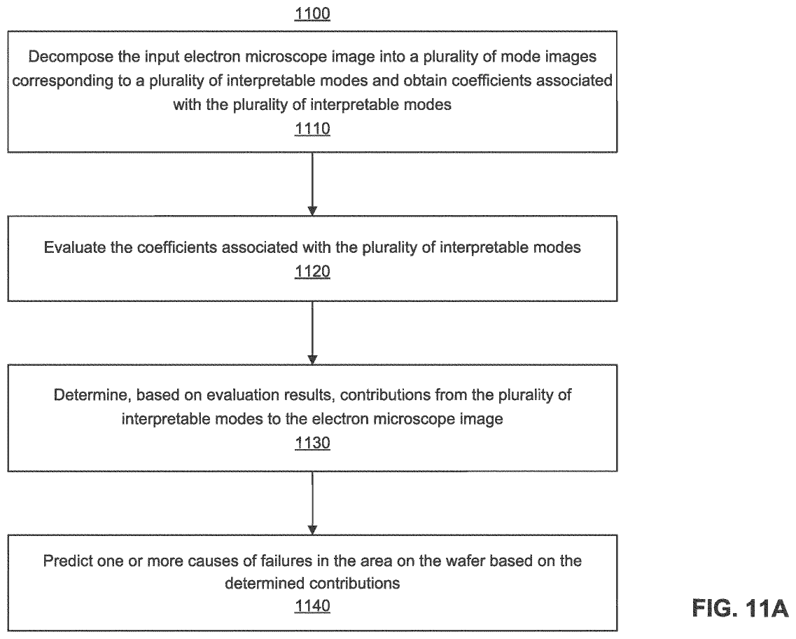

In some embodiments, image analyzer 330 includes classifier model 332 generated by training module 302 using method 500 of FIG. 5. Classifier model 332 can include a neural network model (e.g., as shown in FIG. 6) or a logistic classifier model (e.g., as shown in FIG. 10). In the embodiments that classifier model 332 includes a neural network model, the coefficients associated with respective decomposed interpretable modes can be evaluated by the neural network model to obtain evaluation results, indicating whether a respective category of defect, corresponding to a certain interpretable mode, is likely to exists in the input SEM image or not.

In some embodiments, image analyzer 330 further includes regression model 334 configured to calculate contributions from respective decomposed interpretable modes to the input SEM image. In some embodiments, regression model 334 includes a polynomial model, such as a linear model, a quadratic model or a polynomial model having a combination of different orders. For example, based on the neural network model and the evaluation results obtained from applying classifier model 332 to the coefficients of the decomposed modes associated with the input image, the linear model can approximate a linear relationship between the neural network model and the evaluation results. Such quantified linear relationship can be used to determine contributions from respective interpretable modes to the input SEM image. Accordingly, result 350 can identify one or more categories of defects corresponding to one or more interpretable modes with significant contributions to the input image.

FIG. 6 illustrates a diagram flow representing an example process 600 for predicting categories of defects (e.g., represented by interpretable modes) on a wafer, consistent with some embodiments of the present disclosure. In some embodiments, one or more steps of process 600 are performed by one or more components of system 300 in FIG. 3 (e.g., analyzing module 304), or controller 109 or system 199 in FIG. 1. As disclosed in the present disclosure, process 600 can predict not only whether a defect exists or not based on an SEM image, but also a category of the defect (e.g., also interchangeably referred to as a “type of the defect” or “cause of the defect” or an “interpretable mode” herein). As such, process 600 is beneficial for early detection and correction of defects, as categories of defects can be predicted at an early stage, such as after development in lithography.

In some embodiments, image acquirer 340 obtains an input SEM image 610 from controller 109, system 199, or electron beam tool 104. As shown in FIG. 6, in some embodiments, input SEM image 610 reflects an area of a contact hole that is processed after development in lithography.

In some embodiments, image analyzer 330 decomposes input SEM image 610 into a plurality of mode images 620, each corresponding to a particular interpretable mode, e.g., each interpretable mode associated with a category of defect. Image analyzer 330 obtains coefficients (e.g., C1, C2, C3, C4, C5 . . . ) associated with the interpretable modes respectively. Mode images 620 can be obtained by decomposing input SEM image 610 using PCA (e.g., as illustrated in FIGS. 4A-4B), or any other suitable method. In some embodiments, the plurality of modes 620 may correspond to different categories of defects, such as small CD, shift, ellipticity, blurry edges, printed contact hole, missing contact hole, or bridging contact hole. For example, a defect with small CD corresponds to the size or radius of the contact hole being changed. In another example, a shift defect corresponds to the location of the contact hole up or down being moved from its intended location (e.g., from design). As such, a certain decomposed mode can demonstrate a deviance (e.g., in size, location, shape, contract, intensity, or any other factor) compared to the original input SEM image.

In some embodiments, image analyzer 330 further determines which interpretable mode(s), and to what extent, contribute to input SEM image 610 based on decomposed mode images 620 using one or more models. For example, image analyzer 330 can calculate quantitative contributions from respective interpretable modes, so as to determine whether a respective interpretable mode considerably contributes to the input SEM image. Accordingly, it can be determined whether the input SEM image has the corresponding defect.

In some embodiments as shown in FIG. 6, training module 302 can train a classifier model 630 (e.g., similar to classifier model 332 as discussed with reference to FIGS. 3-5) based on training SEM images. Image analyzer 330 can then use classifier model 630, e.g., a pre-trained neural network model as shown in FIG. 6, to calculate the associated evaluation results 640. In some embodiments, input of classifier model 620 includes the coefficients (e.g., C1, C2, C3, C4, C5 . . . ) associated with the interpretable modes respectively. For example, a classifier model (or classifier model 332) can be represented by the following equation:

y=ƒx₁, x₂, . . . , xₙ) (1)

where ƒ represents a function of a nonlinear model (e.g., classifier model 630), y is the output of the function (e.g., the evaluation results), and xᵢ (i=1, 2, . . . , n) are inputs of the function. In some embodiments, inputs xᵢ (i=1, 2, . . . , n) may include coefficients associated with respective interpretable modes that are obtained from the decomposition process using PCA. The present disclosure is not limited to any specific form of the function or the nonlinear model.

In some embodiments, for each decomposed mode image, a corresponding evaluation result y indicates whether the corresponding category of defect exists in the input SEM image. For example, as shown in FIG. 6, when an evaluation result y is a positive value (e.g., “predict printing”), it can be determined that a defect corresponding to such mode does not exist in input SEM image 610. On the other hand, when an evaluation result y is a negative value (e.g., “predict missing”), it can be determined that a defect corresponding to such mode exists in the input SEM image 610. However, this discussion is merely exemplary. The model can be trained to predict any other categorizations or any number of categories without departing from the scope of the present disclosure.

After obtaining evaluation results 640, a polynomial regression model, such as a linear model 650, can be used to approximate a linear relationship between classifier model 630 (e.g., represented by the non-linear function ƒ in equation (1)) and evaluation results 640 (e.g., represented by the evaluation result y in equation (1)). Parameters, such as coefficients associated with respective interpretable modes, can be obtained from the approximated linear relationship to determine the contributions from respective interpretable modes. For example, linear model 650 can be represented by the following equation:

$$y = {f}_{0} ( {x}_{1 , 0} , {x}_{2 , 0} , … , {x}_{n , 0} ) + {{\sum }_{i = 1}}^{n} \frac{df ( {x}_{1 , 0} , {x}_{2 , 0} , … , {x}_{n , 0} )}{{dx}_{i}} Δ {x}_{i} = constant + {w}_{1} Δ {x}_{1} + {w}_{2} Δ {x}_{2} + … + {w}_{n} Δ {x}_{n} = constant + {b}_{1} + {b}_{2} + … + {bx}_{n} \qquad ( 2 )$$

where y is the output (same as in equation (1)), ƒ₀ represents a constant, Δxᵢ (i=1, 2, . . . , n) are input values related to respective coefficients of interpretable modes, wᵢ are weights associated with respective interpretable modes obtained from the linear approximation (e.g., wᵢ are independent from the input values Δxᵢ), and bᵢ are values associated with respective interpretable modes (e.g., dependent on the input values Δxᵢ). In some embodiments, the linear approximation can use any suitable linear mode, such as Taylor expansion. As such, quantitative contributions (e.g., wᵢ) from respective interpretable modes can be calculated, and whether a respective mode contributes sufficiently to the input SEM image can be determined accordingly. For example, if a certain weight wᵢ is close to 0, it can be determined that the corresponding mode does not contribute to input SEM image 610. If a certain weight wᵢ is positive, it can be determined that the corresponding mode contributes to a positive decision of non-failure, e.g., the corresponding type of defect does not exist in input SEM image 610. If a certain weight wᵢ is negative, it can be determined that the corresponding mode contributes to a failure, e.g., the corresponding type of defect exists in input SEM image 610.

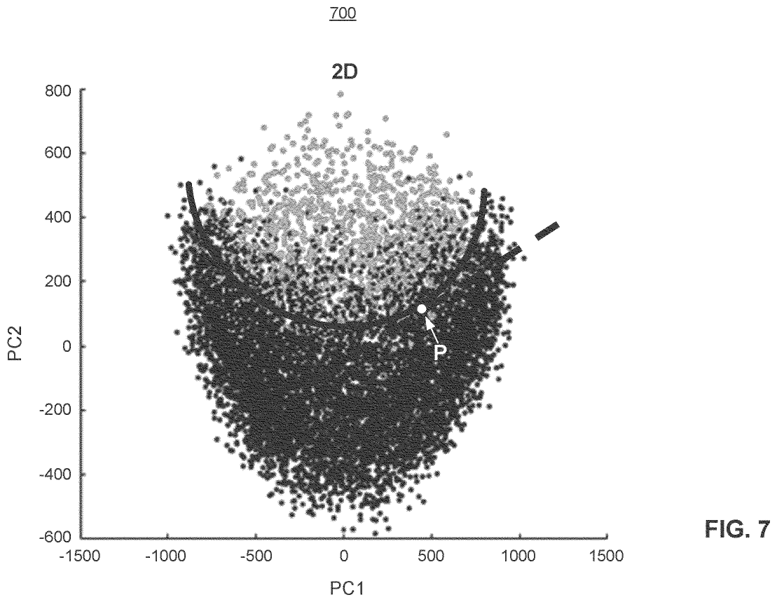

FIG. 7 illustrates a diagram 700 visualizing a non-liner classifier model (e.g., classifier model 630) and a linearized model (e.g., linear model 650) being applied to a plurality of SEM images decomposed into two interpretable modes, consistent with some embodiments of the present disclosure. It will be understood that the two-dimensional (2D) visualization of FIG. 7 is intended to be illustrative only and not to be limiting. A person with ordinary skill in the art will understand that similar concept can be applied to multi-dimensional space for predicting more than two interpretable modes corresponding to multiple types of defects associated with SEM images.

In some embodiments, a plurality of SEM images corresponding to various areas on a plurality of wafers are obtained. Each SEM image can be decomposed and characterized by two interpretable modes marked as PC1 and PC2. Each point in FIG. 7 corresponds to an SEM image decomposed into the two interpretable modes. For example, the coordinates of each point correspond to coefficients associated with the two decomposed interpretable modes obtained from PCA. As shown in FIG. 7, the solid line represents a nonlinear decision boundary of classifier model 630.

In some embodiments, point P in diagram 700 corresponding to input image 610 can be identified in diagram 700, and neighboring points of point P and within an area of interest can be used to for the linearization process as discussed in FIG. 6. For example, considering point P and its neighboring points in diagram 700, linear model 650 can be built for linearizing the non-linear classifier model 630 to represent a linearized relationship between classifier model 630 and its evaluation results of the respective interpretable modes. As shown in FIG. 7, the dashed line shows a linearization result (e.g., or a local linear approximation) of the non-linear decision boundary for point P and its neighboring points within the area of interest (e.g., a contact hole).

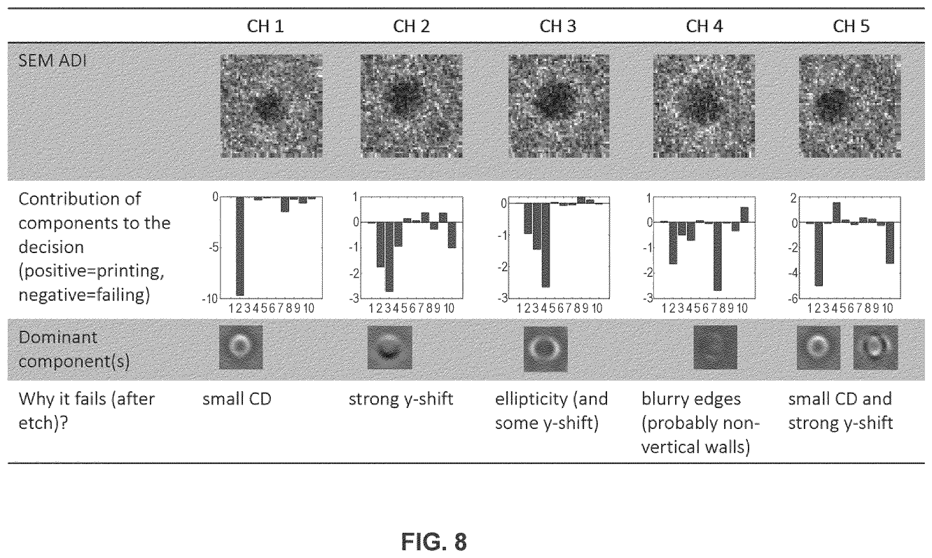

FIG. 8 illustrates examples of visualized prediction results obtained by performing process 600 on input SEM images, in accordance with some embodiments of the present disclosure. In some embodiments, the bar charts in FIG. 8 visualize contribution of the interpretable modes to the decision results. For example, each bar can be plotted to be either pointing down (e.g., negative wᵢ value from the above equation (2)) indicating that the corresponding type of defect exists, or pointing up (e.g., positive wᵢ value from the above equation (2)) indicating the corresponding type of defect does not exist. In addition, the magnitude of each bar is determined by the value of bᵢ determined from the above equation (2) to illustrate the significance of the contribution from the corresponding type of defect to the input SEM image. Accordingly, which category of defect and how significant is the contribution can be determined by the direction and magnitude of each bar.

For example, as shown in FIG. 8, the first input SEM image (“CH 1”) of an area on a wafer after development may be determined to have the second bar extending negative direction and having the greatest magnitude. The second bar (mode 2) corresponds to a CD-typed component. Accordingly, it can be predicted that this area on the wafer after etching (or at other stage(s) during semiconductor processing) is likely to have a defect (or a major defect) of small CD.

As shown in FIG. 8, the second input SEM image (“CH 2”) of an area on a wafer after development may be determined to have the third bar extending negative direction and with the greatest magnitude. The third bar (mode 3) corresponds to a y-shift-typed component. Accordingly, it can be predicted that this area on the wafer after etching is likely to have a defect (or a major defect) of strong shift along y-direction.

In some embodiments, process 600 can also predict multiple types of defects contribute to the failure of the area on the wafer. For example, the third, fourth, and fifth input SEM images (“CH 3,” “CH 4,” and “CH 5”) can be determined to mainly have defects of ellipticity and some y-shift, blurry edges contributing to non-vertical walls, and small CD and strong y-shift, respectively. It will be appreciated that, depending on the algorithm of image decomposition, a plurality of modes can be used to indicate another classification, e.g., defect-related classification. Therefore, the present disclosure can be utilized for classifying the images by any other suitable criteria based on the specific correlations between the classification and the plurality of modes.

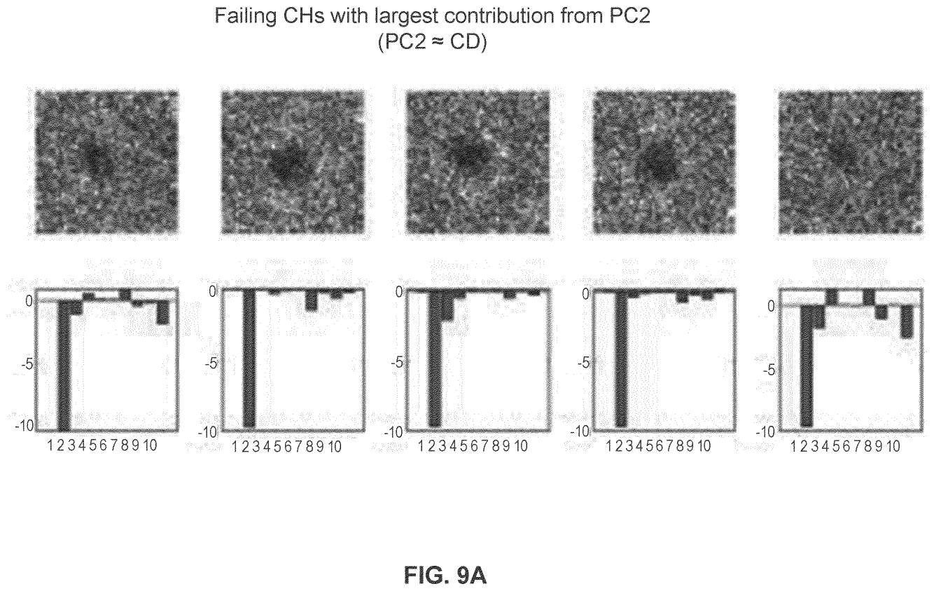

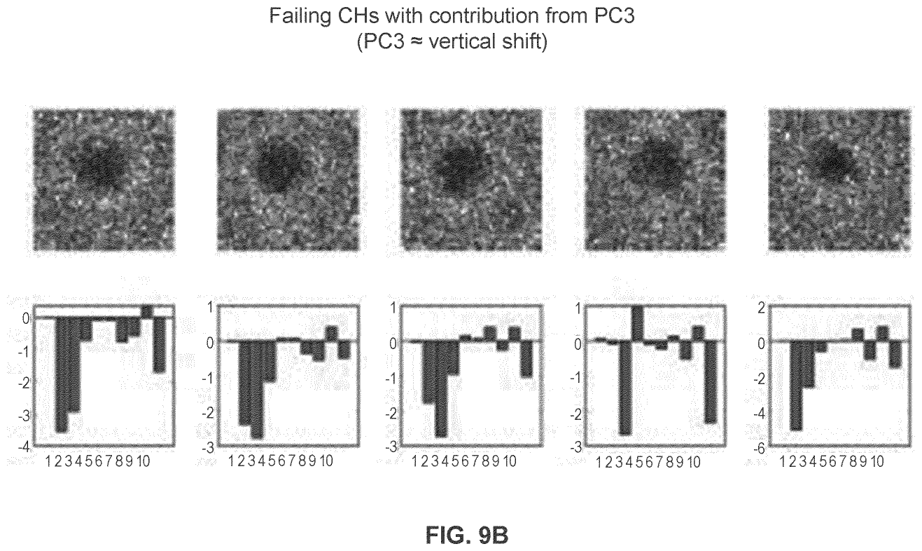

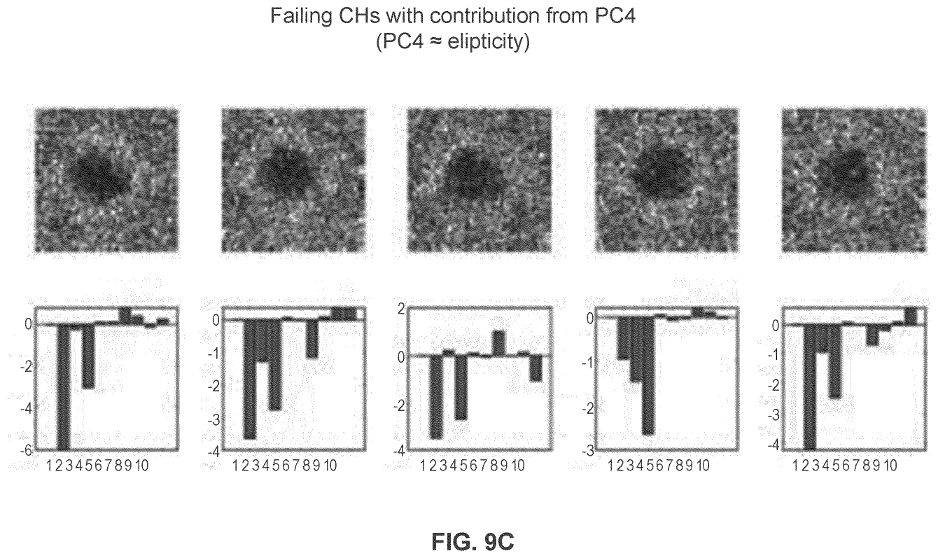

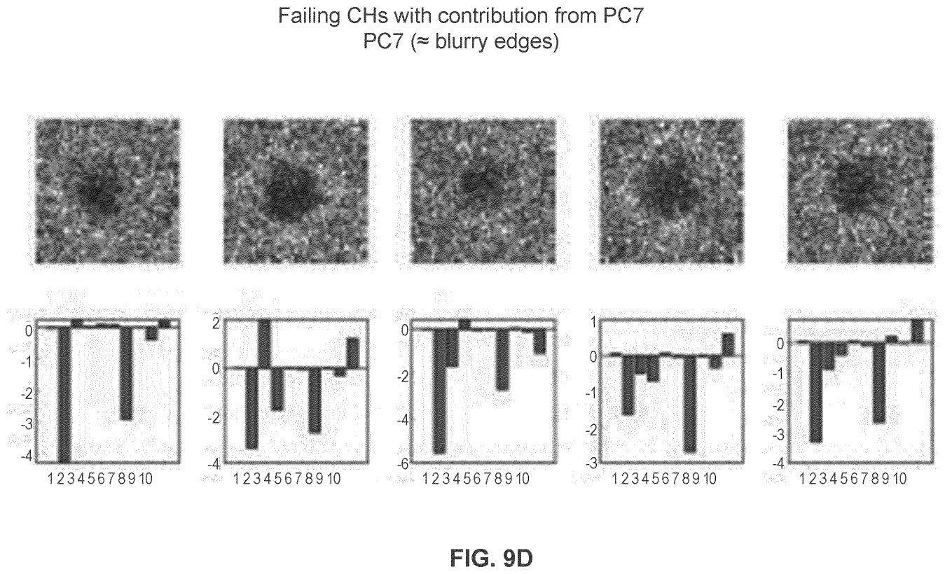

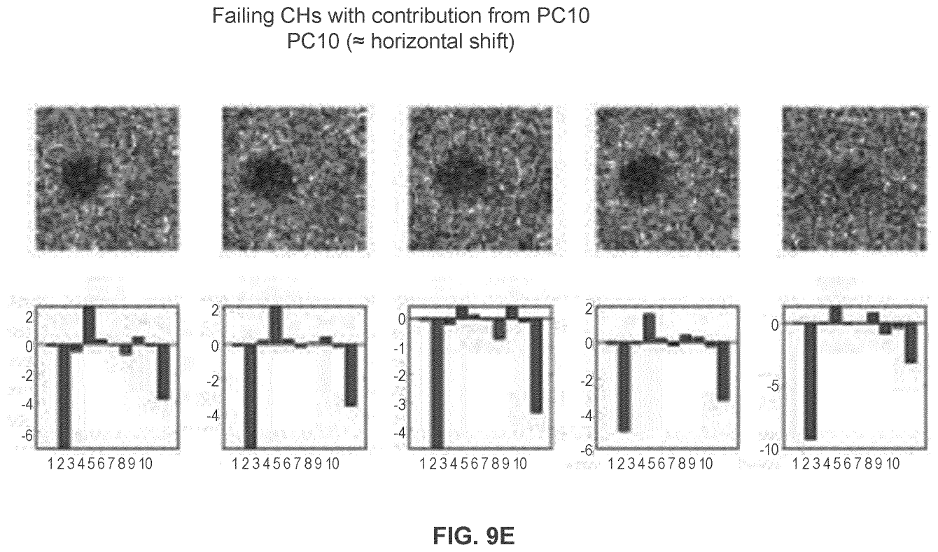

FIGS. 9A-9E further illustrate examples of visualized prediction results (e.g., as in bar charts) obtained by performing process 600 on various input SEM images, in accordance with some embodiments of the present disclosure. For example, as shown in FIG. 9A, the bar chart of each SEM image in FIG. 9A shows the second bar (mode 2) extending negative direction and having the greatest magnitude. Accordingly, each wafer in FIG. 9A after etching is likely to have a defect (or a major defect) of small CD.

Similarly, from the bar charts in FIG. 9B, it shows that each wafer in FIG. 9B after etching is likely to have a defect (or a major defect) of a vertical shift (corresponding to the long and negative third bar in mode 3). Further, based on the magnitudes of the bars, it can be interpreted that the first wafer and the fifth wafer in FIG. 9B are likely to have a more dominant defect of small CD, as evidenced by the longest and negative second bar in respective bar charts.

The bar charts in FIG. 9C show that each wafer in FIG. 9C after etching is likely to have at least one defect (e.g., either a major defect or a defect among multiple defects) of ellipticity, as evidenced by the long and negative fourth bar. Based on the magnitudes of the bars in respective SEM images, it can be understood that ellipticity defect is likely to be the dominant defect in the fourth wafer. Further, the first, second, third, and fifth wafers are likely to have a more dominant defect of small CD, as evidenced by the longest and negative second bar in respective bar charts.

The bar charts in FIG. 9D show that each wafer in FIG. 9D after etching is likely to include a defect (e.g., either a major defect or a defect among multiple defects) of blurry edges, as evidenced by the long and negative seventh bar. It can be interpreted that blurry edges are likely to be the dominant defect in the fourth wafer. Further, the first, second, third, and fifth wafers are likely to have a more dominant defect of small CD, as evidenced by the longest and negative second bar in respective bar charts. In addition, the second wafer is likely not to have defect associated with vertical shift, as evidenced by the noticeable positive bar corresponding to the third component.

The bar charts in FIG. 9E show that each wafer in FIG. 9E after etching is likely to include a defect (e.g., either a major defect or a defect among multiple defects) of horizontal shift, as evidenced by the long and negative fourth bar. Further, each wafer is likely to have a more dominant defect of small CD, as evidenced by the longest and negative second bar in respective bar charts. In addition, the first, second, and fourth wafers are likely not to have defect associated with ellipticity, as evidenced by the positive bars corresponding to the fourth component.

FIG. 10 illustrates an example of visualized prediction results (e.g., as in bar charts) obtained using a logistic classifier model, in accordance with some embodiments of the present disclosure. In some embodiments, the classifier model for classifying different categories of defects may include a logistic classifier model. For example, the logistic classifier model may include a logistic regression model, which can be used for predicting different categories of defects by outputting binary results indicating whether certain categories are likely to exist or not. As such, the important components (e.g., important categories of defects) for the input SEM images can be directly identified, as shown in FIG. 10. In some embodiments, the black bars may correspond to wᵢ calculated from the above equation (2) to indicate whether a certain type of defect exists or not. The white bars may correspond to bᵢ determined from the above equation (2) to indicate the significance of the contribution from the corresponding type of defect to the input SEM image. For example, based on the magnitudes of the white bars shown in FIG. 10, it may be determined that the second, third, fourth, seventh, tenth, and fifteenth components are the main contributing defects to the input SEM image.

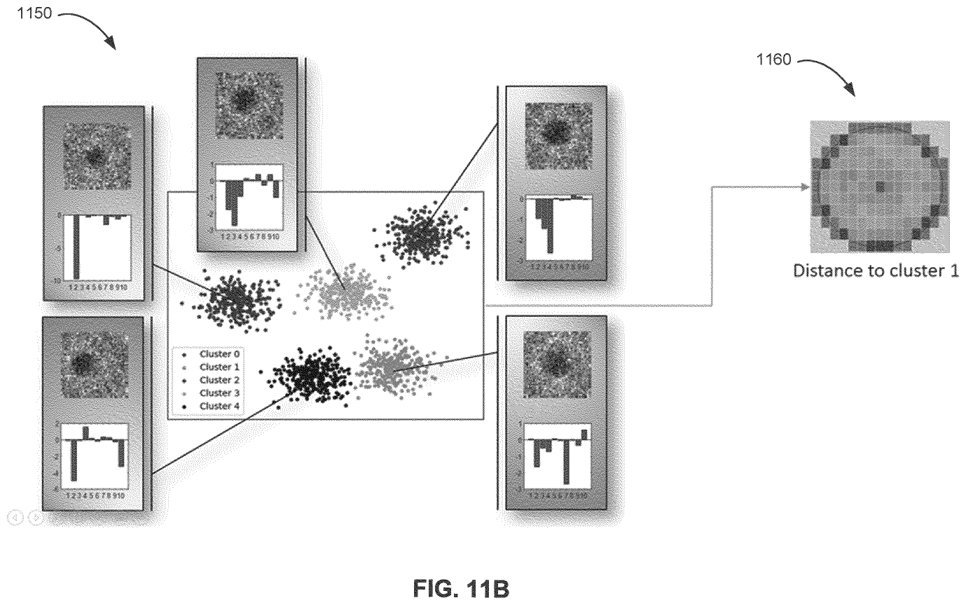

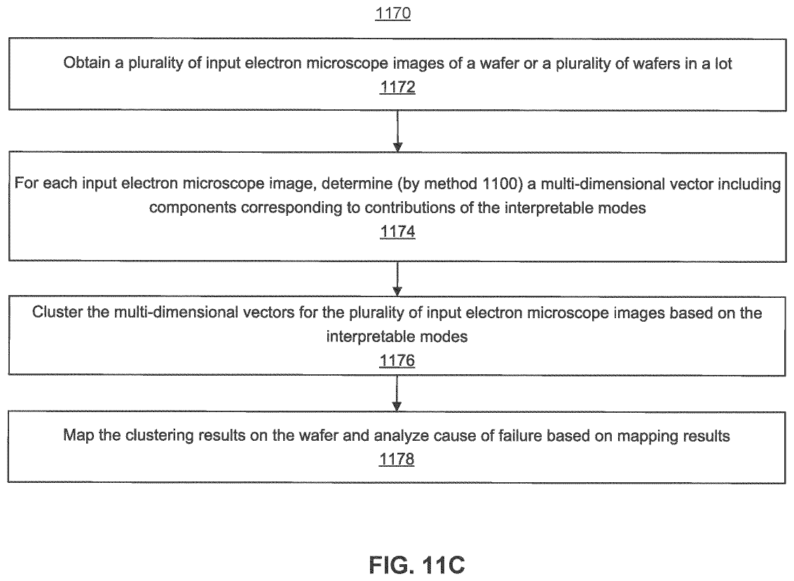

FIG. 11A is a process flowchart representing an example method 1100 for predicting failure modes, such as categories of defects, based on input SEM images, consistent with some embodiments of the present disclosure. In some embodiments, one or more steps are performed by one or more components of system 300 in FIG. 3, controller 109 or system 199 in FIG. 1, or system 100 in FIG. 1.

In step 1110, a plurality of mode images (e.g., mode images 620, FIG. 6) corresponding to a plurality of interpretable modes are obtained by decomposing an input electron microscope image (e.g., input image 610, FIG. 6). A plurality of coefficients (e.g., C1, C2, C3, . . . of FIG. 6) associated with the plurality of interpretable modes respectively can be obtained for characterizing the input electron microscope image. For example, the input electron microscope image includes an SEM image, such as input SEM image 610, that is obtained by image acquirer 340 from controller 109, system 199, or electron beam tool 104. In some embodiments, the input electron microscope image may reflect an area on a wafer corresponding to a certain feature, such as a contact hole area. In some embodiments, the input electron microscope image may correspond to a wafer that has been processed after development in lithography, and process 1100 can predict one or more defects that are likely to exist on the wafer after etching. In some embodiments, the input electron microscope image may be decomposed to obtain coefficients associated with respective interpretable modes using PCA or any other suitable method. A respective interpretable mode may be associated with a feature, such as a type of defect, of the corresponding area on the wafer.

In step 1120, the coefficients associated with the plurality of interpretable modes are evaluated. In some embodiments, classifier model 332 or 630, e.g., a convolutional neural network model as shown in FIG. 6 that is trained by process 500, can be applied to evaluate the coefficients of the plurality of mode images. For example, a respective evaluation result indicates a likelihood of existence (e.g., a binary result) of a corresponding interpretable mode in the input electron microscope image. In some embodiments, the coefficients of the plurality of mode images obtained from PCA are applied to the nodes in the input layer of neural network model 630, and the output is the evaluation results, such as a binary result as shown in FIG. 6.

In step 1130, contributions from the plurality of interpretable modes to the input electron microscope image are determined based on the evaluation results obtained from step 1120. In some embodiments, a regression model, such as linear model 650, or any other suitable polynomial model, such as a quadratic model, can be used to approximate the relationship between the non-linear classifier model and the evaluation results. For example, as shown in FIG. 7, point P corresponding to the input SEM image can be chosen, and an area of interest can be identified for performing the linear approximation. In some embodiments as discussed in FIGS. 8 and 9A-9E, coefficients such as wᵢ obtained from the linearization or equation (2) above can be used to determine whether certain modes contribute to the input SEM image (e.g., whether corresponding defects are likely to exist or not), and magnitudes values bᵢ indicate how significant of corresponding modes contribute to the input SEM image.

In step 1140, one or more features, such as the type of defects, can be predicted to be on the wafer based on the determined contributions from step 1130. In some embodiments, the contributions determined in step 1130 can be visualized in charts or graphs, such as bar charts as shown in FIGS. 8 and 9A-9E, to provide the user direct understanding of the various causes of failure in semiconductor manufacturing. In some embodiments, the prediction results obtained from process 1100 can be used to adjust one or more processing parameters in accordance with the identified one or more modes in the area on the wafer.

FIG. 11B illustrates a diagram 1150 visualizing clustering based on interpretable modes of a plurality of SEM images and a mapping diagram 1160 of the clustering results on a wafer, consistent with some embodiments of the present disclosure. In some embodiments, the clustering of diagram 1150 is performed by one or more components of system 300 in FIG. 3 (e.g., analyzing module 304), or controller 109 or system 199 in FIG. 1. In some embodiments, image acquirer 340 obtains a plurality of input SEM images from controller 109, system 199, or electron beam tool 104. In some embodiments, each SEM image includes one or more areas on a wafer, where an area corresponds to a contact hole (e.g., as shown in SEM image 610), or another type of feature. In some embodiments, the plurality of input SEM images correspond to different areas on a wafer. In some embodiments, the plurality of input SEM images correspond to areas on different wafers in a same lot.

In some embodiments, each input SEM image can be processed using one or more steps of process 600 of FIG. 6 or process 1100 of FIG. 11A to identify multiple interpretable modes and quantify the contributions from respective interpretable modes. Examples of the interpretable modes may correspond to different categories of features (e.g., possible causes of defects or failure), such as small CD, shift along a certain direction, ellipticity, blurry edges, printed contact hole, missing contact hole, bridging contact hole, etc. For example, as shown in diagram 1150, for each input SEM image, one or more interpretable modes and quantified contributions from the corresponding interpretable modes are visualized by the bars in the bar charts having different channels with corresponding directions and magnitudes as discussed in FIG. 8. In some embodiments, a multi-dimensional vector composed of a plurality of components can be used to characterize the feature in each input SEM image, where each component corresponds to an interpretable mode with the associated quantification of the contribution to the prediction from the corresponding interpretable mode. For example, a 10-dimensional vector can be used to characterize the feature in a respective SEM image in FIG. 11B, and the 10-dimensional vector including ten components each of which corresponds to a bar in a certain channel in the bar charts.

In some embodiments, clustering is performed to the vectors of a plurality of SEM images of different areas on a wafer based on their similarity of certain component(s). Using 2-dimensional space shown in diagram 1150 as an example, each dot corresponds to an SEM image of an area on the wafer, associated with a 2-dimensional vector (obtained from process 600 or 1100). Vectors having similar components are represented with similar coordinates in the 2-dimensional space, thus distributed in one cluster close to each other, indicating that these areas on the wafer have similar causes of defects based on analysis of the corresponding SEM images. In some embodiments, clustering can also be applied to a plurality of wafers in a lot that are processed together as one group. In some embodiments, any type of suitable clustering algorithm can be used, such as K-Means Clustering, or Mean-Shift Clustering, etc.

After clustering, mapping diagram 1160 of the clustering results can be provided on a wafer to facilitate analysis of the cause of failure. In some embodiments, each dot in clustering diagram 1150 corresponds to the SEM image of the area, and is further associated with area information, such as location information on the wafer (e.g., in which die, or coordinates on the wafer), time information of one or more manufacturing processes performed to the area (e.g., when coating, exposing, baking, developing, etching, polishing, etc. is performed), etc. In some embodiments, a cluster of dots obtained in diagram 1150 can be mapped on a wafer as shown in mapping diagram 1160. Location distribution on the wafer or processing time information can be obtained during mapping, and lithography parameters associated with the distribution of the defects may be analyzed to understand the origin of the defects. For example, contact holes corresponding to a given failure mode (in a cluster) can be mapped across the wafer to visualize the distance between each contact hole and the centroid of that cluster.

In some embodiments, cause of failures can be analyzed based on the mapping result. For example, a cluster of contact holes with small dimension (e.g., cluster 1) may be distributed within the same die on the wafer in mapping diagram 1160. Accordingly, one or more lithography parameters, such as light dose, may be adjusted to cure such defects generated on the corresponding die. In another example, multiple contact holes with blurry edges occur within the same region on the wafer may correspond to focus-related defects or failures. Accordingly, light focus applied to this region during lithography may be adjusted. In another example, multiple contact holes with certain y-shift or x-shift may form a pattern on mapping diagram 1160, suggesting defects generated during the etching or polishing process. Accordingly, etching or polishing parameters, such as etching rate, polishing contact pressure, wafer rotation speed, etc., can be adjusted to improve the etching or polishing process.

In some embodiments, the above-discussed clustering and mapping processes can be applied to SEM images of various areas on wafers in a lot for better understanding the cause of failures. For example, if a batch of wafers contain similar defects at similar locations, e.g., in the same dies, parameters applied to these dies at the time of processing this batch of wafers can be adjusted to cure the defects.

In some embodiments, mapping can also be plotted based on a user selection of a certain parameter, such as a certain type of defect or a cause of defect (e.g., small CD, blurry edges, etc.), a certain region (e.g., a particular die) on the wafer, a certain time or a certain step for processing the wafers or dies, to know what type of defects (or cause of defects) occurred in the selected regions or at a certain time or step, so as to improve the corresponding processes. In some embodiments, in response to a user selection, the distribution of defects on a wafer can be visualized to the user, so that the user can view and determine the cause of failure more efficiently and effectively. In some embodiments, the cause of failure analyzed based on distribution of defects at the wafer-level can be used to project potential issues with other unmeasured or even unprocessed wafers, so as to take advanced corrections to improve the processes. For example, wafer fingerprint for a particular failure mode can be mapped on the wafer and used for monitoring and diagnostics of future wafer measurement and processing.

FIG. 11C is a process flowchart representing an example method 1170 for analyzing failure modes based on input SEM images of a plurality of areas on a wafer (e.g., at a wafer level), consistent with some embodiments of the present disclosure. In some embodiments, one or more steps are performed by one or more components of system 300 in FIG. 3, controller 109 or system 199 in FIG. 1, or system 100 in FIG. 1.

In step 1172, a plurality of input electron microscope images (e.g., including input image 610 of FIG. 6) corresponding to different areas on a wafer are obtained. In some embodiments, a plurality of input electron microscope images may correspond to different areas on different wafers in the same lot.

In step 1174, for each input electron microscope image, a multi-dimensional vector including components corresponding to contributions of the interpretable modes can be determined. In some embodiments, each electron microscope image is processed by one or more steps of process 1100 in FIG. 11A. For example, for each electron microscope image, a plurality of interpretable modes can be analyzed, and contributions from the plurality of interpretable modes to the input electron microscope image are determined. The multi-dimensional vector is composed of components representing the plurality of interpretable modes and the associated contributions.

In step 1176, the multi-dimensional vectors for the plurality of input electron microscope images are clustered based on the interpretable modes. For example, vectors with similar components and associated contributions distribute in the same cluster on a multi-dimensional space (e.g., as shown in FIG. 11B in a two-dimensional space).

In step 1178, the clustering results are mapped, e.g., as shown in mapping diagram 1160 in FIG. 11B, and causes of failures are analyzed based on the mapping results. For example, vectors within a cluster corresponding to a certain interpretable mode can be mapped on a wafer to visualize the distribution of the corresponding areas on the wafer. In some embodiments, a user can also select a parameter, such as selecting a die on a wafer to check what type of defects (or cause of defects) occurred on the die, or selecting a certain defect (or cause of defect) and see the distribution of this type of defects on the wafer.

As discussed herein, by performing processes 500, 600, 1100, or 1150, system 300 can not only provide quantitative assessment of contributions from different types of defects to the failure of the area on the wafer, it may also provide interpretation of such quantitative analysis of individual areas and distribution of the defects at the wafer level to the user. Accordingly, the user can have a more direct understanding of the various causes of failure in semiconductor manufacturing. Further, early detection and correction of the predicted defects becomes possible. For example, the training images and input images can correspond to different areas or layers on wafers that have been processed at different stages of semiconductor processing. This, in turn, can contribute to a systematic improvement of the semiconductor processing. Further, training and using the classifier model may be less complicated and less time-consuming compared to the existing technology, because instead of using pixel values as input, weights (e.g., coefficients) associated with the decomposed modes are used as input in the present disclosure. As such, fewer nodes in the input layer and less complicated neural network are involved, so as to provide more efficient and effective machine learning based defects predicting for semiconductor processing.

Further, the process disclosed in the present disclosure can also be used for root cause analysis. For example, a classifier model can be trained based on interpretable modes corresponding to different processing steps, stages, or parameters during semiconductor processing. Then, ranking of the contributions from the different processing steps, stages, or parameters can be obtained for feature importance detection. In some embodiments, instead of using generic machine learning models, model-specific method for feature importance detect can also be used. For example, when using decision trees for a random forest model, the feature importance can be determined from the position of that feature in the tree (e.g., the higher in the tree the feature is located, the more important the feature may be).

Root cause analysis is important for identifying significant causes of various defects on IC chips, so that the semiconductor manufacturing process can be optimized based on the identified causes. Currently, root cause analysis is mainly performed manually by experienced engineers. For example, experienced personnel may examine defects on microscope images, analyze defective chemical compositions, or conduct tests for electrical failures on IC chips to understand the causes of the defects. However, this manual process can be time-consuming, error-prone, and limited to small number of defect types in small number of samples. As such, there is a need for an automatic process for root cause analysis that can satisfy the need for large-scale IC chips processing with reduced feature size, increased feature density, and more detailed and accurate defect analysis.

To address this issue, the present disclosure provides a method and a system suitable for automatic root cause analysis in large scale semiconductor manufacture processing. For example, predictive models, such as random forest models, can be trained based on image feature data and process feature data. The predictive models can be used to predict formation of defects based on process feature data (such as processing parameters) used for fabricating an input sample for prediction. Further, the predictive models can provide feature importance information that ranks the features to indicate ordering of root causes of the defects.

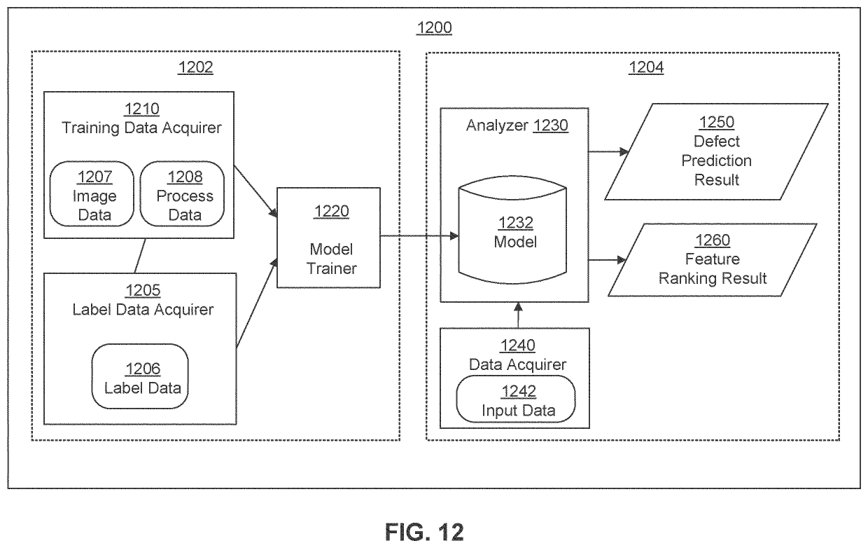

FIG. 12 is a block diagram of an example system 1200 configured to perform root cause analysis based on feature ranking results obtained from predictive models, consistent with some embodiments of the present disclosure. In some embodiments, system 1200 includes a training module 1202 and a predicting module 1204. Training module 1202 includes a training data acquirer 1210, a label data acquirer 1205, and a model trainer 1220. Predicting module 1204 includes an analyzer 1230 including a model 1232 (e.g., generated by pre-trained trainer 1220). Analyzer 1230 can analyze input data obtained by a data acquirer 1240 to generate feature ranking result 12650. Analyzer 1230 can also generate defect prediction result 1250 based on the input data.

In some embodiments, system 1200 comprises one or more processors and memories. For example, system 1200 can comprise one or more computers, servers, mainframe hosts, terminals, personal computers, any kind of mobile computing devices, and the like, or combinations thereof. In some embodiments, training module 1202 and predicting module 1204 are implemented on separate computing devices. In other embodiments, training module 1202 and predicting module 1204 can be implemented on a same computing device. It is appreciated that system 1200 may include one or more components or modules that are integrated as parts of a charged-particle beam inspection system (e.g., electron beam inspection system 100 of FIG. 1). System 1200 may also include one or more components or modules separate from and communicatively coupled to the charged-particle beam inspection system. In some embodiments, system 1200 may include one or more components (e.g., software modules) that can be implemented in controller 109 or system 199 as discussed herein.

In some embodiments as shown in FIG. 12, training module 1202 includes training data acquirer 1210. Training data acquirer 1210 may be configured to obtain training data. The training data may include image data 1207 extracted from a plurality of SEM images of IC chips and process data 1208 associated with fabricating the IC chips. The acquired training data can be fed to model trainer 1220 for training model 1232 (e.g., a prediction model). In some embodiments, training data acquirer 1210 can obtain the training data from a database, controller 109, system 199, or electron beam tool 104. For example, training data acquirer 1210 may include image acquirer of controller 109 as discussed herein for acquiring the plurality of SEM images of the IC chips.

In some embodiments, image data 1207 of the training data may include pixel values, location information, etc. associated with various features or defects on the IC chips. In some embodiments, a respective SEM image may capture an area corresponding to a feature (e.g., one or more contact holes, one or more lines, etc.), a die, or an entire wafer. In some embodiments, image data 1207 may be extracted from SEM images taken of samples processed at different stages, such as after development in lithography, after etching, after metal layer deposition, after chemical mechanical polishing (CMP), etc.

In some embodiments, the process training data acquirer 1210 can further obtain process data 1208 associated with different processes for fabricating of the IC chips used for contributing to the plurality of SEM images for training. In some embodiments, process data 1208 includes, but is not limited to, fabrication data collected from different semiconductor processing or inspection stages, design data used for designing the microcircuits on the IC chips, material information (e.g., composition), and other types of possible causes of defects.

In some embodiments, the fabrication data includes parameters (e.g., also referred to as features) associated with lithography process, etching process, inspection condition, and other processes involved during fabrication. For example, the lithography parameters includes, but are not limited to, the light beam focus, dose and lens aberration values, the wafer leveling, and overlay correction in the double patterning process, etc. The etching parameters include, but are not limited to, etching temperature, etching chemical (e.g., gas) concentration level, and etching duration, etc. The inspection parameters include, but are not limited to, optical inspection condition using bright field or dark field microscope images, magnification, scanning areas, etc., which can be indicative of examination of defects during inspection.

In some embodiments, the design data corresponds to a design architecture to be formed on a plurality of hierarchical layers on a wafer. The design data may be presented in image files and may include characteristics information (e.g., shape, dimension, etc.) for various patterns on different layers. For example, the design data may be related to information associated with various structures, devices, and systems to be fabricated on the wafer, including but not limited to, substrates, doped regions, poly-gate layers, resistance layers, dielectric layers, metal layers, transistors, processors, memories, metal connections, contacts, vias, system-on-chips (SoCs), network-on-chips (NoCs), or any other suitable structures. The design data may further include IC layout design of memory blocks, logic blocks, interconnects, etc. For example, the design data may include parameters or characteristics including, but not limited to, pattern density, location of patterns/features on the microchip reticle/field, which can be associated with defects on the IC chips. In some embodiments, the design data may be in Graphic Database System (GDS) format, Graphic Database System II (GDS II) format, an Open Artwork System Interchange Standard (OASIS) format, a Caltech Intermediate Format (CIF), etc.

In some embodiments, process data 1208 may further include data related to other types of possible causes of defects, such as scratches or residue on the die, and material composition, etc., that can be indicative of which process is the root cause.

In some embodiments, training module 1202 may include label data acquirer 1205 configured to obtain label data 1206 associated with the SEM images from which image data 1207 used for training was obtained. In some embodiments, the SEM images are labeled by classification labels, such as defect or non-defect. In addition to or alternative to binary labels, the SEM images can also be labeled by a plurality of categories corresponding to different types of defects. For example, the categories of defects include, but are not limited to, bridging, necking, missing, merging, small CD, blurry edges, ellipticity, etc. The classification labels can be used for building classification-typed prediction models for predicting classification. In some embodiments, the SEM images can be examined and labeled by an expert based on his or her prior knowledge. In some embodiments, the SEM images can be automatically analyzed and labeled using an automatic program. For example, principal component analysis (PCA) or singular value decomposition (SVD) method. In some embodiments, the SEM images are labeled by regression labels, e.g., based on continuous pattern sizes. The regression labels can be used for building regression-typed prediction models. For example, computer vision algorithms can be used to classify areas of interest (or patterns of interest) as defect or non-defect, or measure the continuous pattern sizes. For example, patterns of interest can be classified as pattern break or pattern bridging. In another example, patterns of interest can also be measured by sizes distributed in different ranges, such as a range of 5-10 nm, etc.

In some embodiments, model trainer 1220 of training module 1202 can train prediction model 1232 based on the training data and the corresponding label data. In some embodiments, prediction model 1232 is based on feature ranking algorithms. For example, various features or parameters that may be correlated to formation of defects are ranked, so that factors that are more related to the cause of defects can be selected, and noises or irrelevant variables can be removed for more effective and efficient root cause analysis. In some embodiments, prediction model 1232 is based on model-specific algorithms or model-agnostic algorithms.

In some embodiments, model 1232 includes a random forest model that is built on a plurality of random decision trees. The random forest model can average the plurality of deep decision trees, trained on different subsets from the training data with the goal of reducing the variance. In some embodiments, each random decision tree is trained (by model trainer 1220) based on a plurality of randomly selected features or parameters from the training data, where a respective feature of the training data may be placed at a node of a tree. At each node, it is determined whether the selected corresponding feature can sufficiently contribute to the overall goal of reducing variance (e.g., whether the feature is an important feature or a nuisance feature to be removed). Accordingly, during training, a series of evaluations can be performed at each of the nodes of a respective decision tree, and the results obtained from multiple trees are averaged to determine feature importance. Impurity values can be calculated to rank the features.

In some embodiments, after collecting training data including image data 1207, process data 1208, and label data 1206, model trainer 1220 determines a best feature for splitting the data. The collected data can then be split into subsets that contain values for the best feature. In some embodiments, different metrics may be used for quantitatively measuring the splitting quality. In some embodiments, for regression labels (e.g., based on continuous pattern sizes, and used for building regression-typed prediction model), impurity values can be calculated based on mean square error as defined below:

$$E = \frac{1}{N} {\sum }_{i = 1}^{N} {( {y}_{i} - μ )}^{2}$$

or absolute error:

$$E = \frac{1}{N} {\sum }_{i = 1}^{N} \vert {y}_{i} - μ \vert$$

where yᵢ is the label for an instance, N is the number of instances and u is the mean determined by:

$$μ = \frac{1}{N} {\sum }_{i = 1}^{N} {y}_{i}$$

In some embodiments, for classification labels used for building classification-typed prediction model, impurity values can be calculated using a Gini Impurity:

$$E = {\sum }_{i = 1}^{c} {p}_{i} * ( 1 - {p}_{i} )$$

### or Entropy:

$$E = {\sum }_{i = 1}^{c} - {p}_{i} * log ( {p}_{i} )$$

where pᵢ is the frequency of label i at a node, and c is the number of classes.

In some embodiments, the selection of the feature and the splitting point to place the feature can be chosen using a greedy algorithm to minimize the impurity value. For example, different splitting points can be iteratively tried out, and the splitting points on the decision tree that provide the lowest impurity value are selected. In addition, at each split in a respective decision tree, the improvement in the split-criterion is the importance measure attributed to the splitting variable, and is accumulated over all the decision trees in the random forest model separately for each variable.

In some embodiments, after determining the best feature at the best splitting point that best split a decision tree, model trainer 1220 further recursively generates new tree nodes using the subset of data split based on the best feature, until an optimized best accuracy and minimized number of splits can be obtained. As such, model trainer 1220 can build a collection of de-correlated decision trees to get the averaged results, so as to reduce the variance of an estimated prediction function. In some embodiments, during training, each decision tree in a random forest can learn from a random sample of the data points, and some samples may be used multiple times in a single decision tree. In some embodiments, only a subset of all the features collected from training data are considered for splitting each node in a respective decision tree.

In some other embodiments, prediction model 1232 is based on a polynomial regression model for defect prediction. A sequential selection algorithm, such as a sequential forward selection (SFS) or a sequential backward selection (SBS) algorithm, can be used to determine feature importance. Percentage of contribution from each feature can also be calculated. For example, SFS algorithm starts from an empty set of data and adds one feature per step that gives the highest value for the objective function (such as classification accuracy) of the corresponding step. The process is repeated until the required number of features are added. SBS algorithm, on the other hand, starts from a complete set of variables and removes one feature at a time whose removal gives the lowest decrease in objective performance. In some embodiments, SFS and SBS can also be combined. In some embodiments, prediction model 1232 can include any other suitable machine learning model, such as linear regression model, logistic regression model, XGBoost model, etc.

In some embodiments, predicting module 1204 includes data acquirer 1240 configured to obtain input data 1242 for predicting root causes for a failure associated with a wafer. In some embodiments, input data 1242 includes image data extracted from an input image, such as an SEM image, from electron beam tool 104, controller 109, or system 199 as shown in FIG. 1. In some embodiments, the input image may correspond to an area of interest on the wafer that requires defect prediction, such as an area of one or more contact holes, one or more lines, a die, or an entire wafer. In some embodiments, the input image may be an SEM image of a wafer taken at different stages during semiconductor processing, such as after development in lithography, or after etching. The image data may include pixel values, location information, etc. associated with features or defects in the area of interest on the wafer.

In some embodiments, input data 1242 further includes process data associated with fabrication, inspecting, or other steps of processing the wafer. For example, the process data includes fabrication data, such as lithography parameters, etching parameters, inspection condition, or other fabrication processes. The process data may further include design data or other factors that may be related to causes of defects.

In some embodiments, predicting module 1204 includes analyzer 1230 configured to analyze input data 1242 using model 1232 including a plurality of decision trees generated by model trainer 1220 as discussed above. In some embodiments, predictions for input data 1242 can be made by averaging the predictions from all the individual decision trees on input data 1242 for regression-typed models, or by taking the majority vote from results of the decision trees in the case of classification-typed models.

In some embodiments, after fitting input data 1242 using the trained model 1232, analyzer 1230 can generate defect prediction result 1250. For example, defect prediction result 1250 may include whether there is one or more defects based on input data 1242, what types of defect may exist, or locations of the defects on the wafer. In some embodiments, defect prediction result 1250 may be used to cause an area on the wafer corresponding to the predicted locations of the defects to be measured or evaluated. For example, according to predicted defect type or location, one or more components of controller 109 and system 199 can control electron beam tool 104 to scan the corresponding area. In some embodiments, analyzer 1230 can also generate feature ranking result 1260. For example, a subset of the nodes of the decision trees corresponding to the predicted important features (e.g., processing steps or parameters) that may contribute more significantly than others to the formation of the defects can be identified. In some embodiments, and a visualized ranking result can be further outputted to facilitate the root cause analysis.

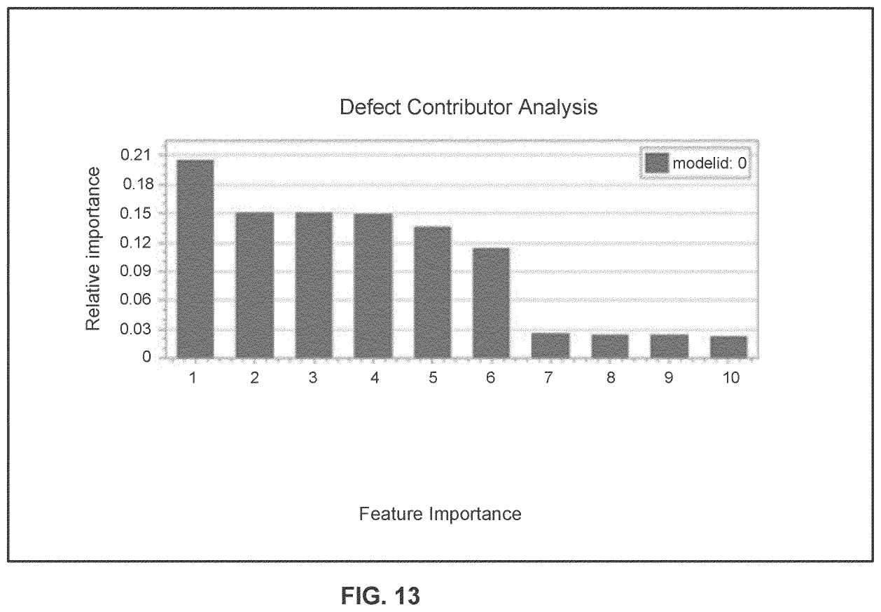

FIG. 13 illustrates an example of visualization of feature importance in accordance with feature ranking result 1260, in accordance with some embodiments of the present disclosure. For example, the bar charts in FIG. 13 visualize respective feature importance based on ranking result 1260 analyzed by predicting module 1204, so as to provide the user direct understanding of the relevant processes or parameters that can cause defects during semiconductor processing.

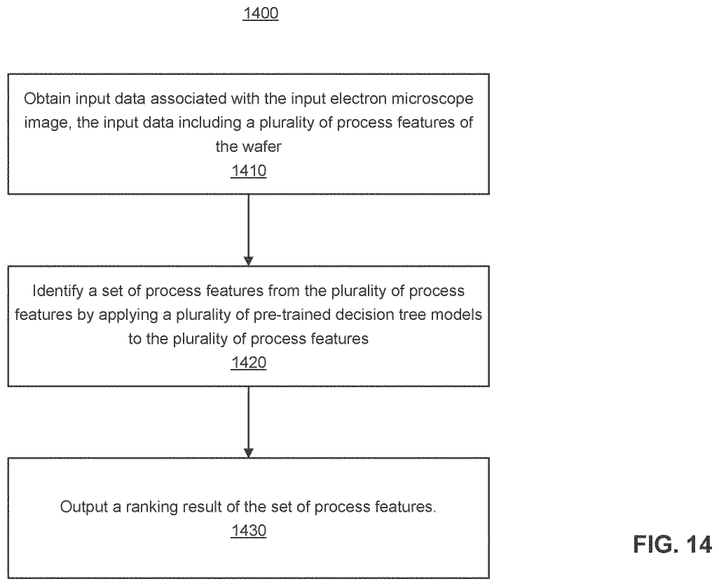

FIG. 14 is a process flowchart representing an example method 1400 for performing an automatic root cause analysis, consistent with some embodiments of the present disclosure. In some embodiments, one or more steps are performed by one or more components of system 1200 in FIG. 12, controller 109 or system 199 in FIG. 1, or system 100 in FIG. 1.

In step 1410, input data (e.g., input data 1242, FIG. 12) associated with an input electron microscope image (e.g., an SEM image) of a wafer can be obtained (e.g., by data acquirer 1240). In some embodiments, the input data includes image data extracted from the input image, such as pixel values, or location information, etc. associated with features or defects in an area of interest on the wafer. In some embodiments, the input data also includes a plurality of process features associated with fabrication, inspecting, or other steps of processing the wafer. For example, the process features includes fabrication data, such as lithography parameters, etching parameters, inspection condition, or other fabrication processes. The features data may further include design data or other factors that may be related to causes of defects.

In step 1420, a set of process features from the plurality of process features are identified by applying a plurality of pre-trained decision tree models to the plurality of process features. In some embodiments, model trainer 1220 can train a plurality of pre-trained decision tree models using training data including image data 1207 and process data 1208 obtained by training data acquirer 1210 and label data 1206 obtained by label data acquirer 1205 as discussed in FIG. 12. In some embodiments, the plurality of pre-trained decision tree models are part of a random forest model, an XGBoost model, or a decision tree classification model. In some embodiments, the plurality of decision tree models can be trained on different subsets of the training data (e.g., randomly selected process features), and a random forest model (e.g., model 1232, FIG. 12) can be constructed by averaging the plurality of decision tree models with a goal of reducing the variance of an estimated prediction function. In some embodiments, while training a respective decision tree, different metrics can be used for measuring splitting quality of randomly selecting features for the nodes of the decision tree. For example, impurity values (such as Gini Impurity) can be calculated for each node of the decision tree to select a feature as a splitting point at the corresponding node which results in the greatest reduction in Gini Impurity. In some embodiments, the subsets of features for the plurality of pre-trained decision tree models are randomly selected, the pre-trained decision tree models and decorrelated, and the set of process features are identified based on averaging results from applying the plurality of pre-trained decision tree models to the plurality of process features.

In step 1430, a ranking result (e.g., bar charts in FIG. 13) of the set of process features can be outputted. In some embodiments, analyzer 1230 can output feature ranking result 1260 that ranks the set of process features corresponding to the important features (e.g., including processing steps or parameters) predicted based on input data 1242 using the plurality of pre-trained decision tree models (e.g., for a random forest model).

In some embodiments, analyzer 1230 can also output defect prediction result 1250 associated with types or locations of one or more defects that are predicted to be formed on the wafer associated with input data 1242. In some embodiments, an evaluation of an area of the wafer corresponding to input data 1242 is performed by one or more components of system 100, controller 109, or system 199 in FIG. 1. For example, instructions can be generated to cause the charged-particle beam inspection system as discussed herein (e.g., system 100 or electron beam tool 104) to perform inspections of areas of the wafer according to defect prediction result 1250. In some embodiments, the inspection may be performed on one or more areas of the wafer corresponding to the predicted locations of the defects. In some embodiments, the inspection may also be performed using one or more inspection parameters in accordance with the predicted types of the defects. In some embodiments, the inspection images and the corresponding inspection results can be used to further evaluate or improve model 1232.

A non-transitory computer readable medium may be provided that stores instructions for a processor (e.g., processor of controller 109, system 199, system 300, or system 1200) to carry out, among other things, various steps as discussed in processes 500, 600, 1100, and 1400. Common forms of non-transitory media include, for example, a floppy disk, a flexible disk, hard disk, solid state drive, magnetic tape, or any other magnetic data storage medium, a Compact Disc Read Only Memory (CD-ROM), any other optical data storage medium, any physical medium with patterns of holes, a Random Access Memory (RAM), a Programmable Read Only Memory (PROM), and Erasable Programmable Read Only Memory (EPROM), a FLASH-EPROM or any other flash memory, Non-Volatile Random Access Memory (NVRAM), a cache, a register, any other memory chip or cartridge, and networked versions of the same.

The embodiments may further be described using the following clauses:
1. A method of analyzing an input electron microscope image of a first area on a first wafer, the method comprising:
   obtaining a plurality of mode images from the input electron microscope image corresponding to a plurality of interpretable modes;
   evaluating the plurality of mode images;
   determining, based on evaluation results, contributions from the plurality of interpretable modes to the input electron microscope image; and
   predicting one or more characteristics in the first area on the first wafer based on the determined contributions.
2. The method of clause 1, wherein a respective interpretable mode of the plurality of interpretable modes is associated with a characteristic of the first area on the first wafer.
3. The method of any one of clauses 1-2, wherein obtaining the plurality of mode images comprises:
   decomposing the input electron microscope image into the plurality of mode images.
4. The method of any one of clauses 1-3, wherein obtaining the plurality of mode images comprises:
   obtaining coefficients associated with the plurality of interpretable modes respectively corresponding to the input electron microscope image.
5. The method of any one of clauses 1-4, wherein the one or more characteristics correspond to one or more categories of defects respectively.
6. The method of any one of clauses 1-5, wherein the one or more categories of defects comprise small critical dimension (CD), shift along a certain direction, ellipticity, blurry edges, printed contact hole, missing contact hole, or bridging contact hole.
7. The method of any one of clauses 1-6, wherein evaluating the plurality of mode images comprises:
   applying a classifier model to the coefficients associated with the plurality of interpretable modes respectively to obtain output including the evaluation results.
8. The method of any one of clauses 1-7, wherein the classifier model is a logistic regression, a support vector machine, or a neural network model.
9. The method of any one of clauses 1-8, wherein evaluating the plurality of mode images comprises:
   obtaining the evaluation results each of which indicates a likelihood of existence of corresponding interpretable modes.
10. The method of any one of clauses 1-9, wherein determining the contributions from the plurality of interpretable modes to the input electron microscope image comprises:
   approximating the classifier model using a polynomial regression model.
11. The method of any one of clauses 1-10, wherein the polynomial regression model includes a linear model.
12. The method of any one of clauses 1-11, wherein determining the contributions from the plurality of interpretable modes to the input electron microscope image comprises:
   determining, from a linear approximation using the linear model, weights associated with the plurality of interpretable modes, respectively.
13. The method of any one of clauses 1-12, further comprising:
   generating a visualization representing the contributions from the plurality of interpretable modes to the input electron microscope image.
14. The method of any one of clauses 1-13, further comprising:
   adjusting one or more processing parameters in accordance with the one or more characteristics in the area on the wafer.
15. The method of any one of clauses 1-14, further comprising:
   determining defect causes based on the determined contributions from the plurality of interpretable modes.
16. The method of any one of clauses 1-15, further comprising:
   training the classifier model based on (1) training electron microscope images of a plurality of wafers and (2) label data of the training electron microscope images corresponding to coefficients of a plurality of interpretable modes associated with each of the training electron microscope images.
17. The method of any one of clauses 1-16, wherein the input electron microscope image is a scanning electron microscope (SEM) image of the first area on the first wafer that has been processed at a first stage prior to the first stage, and wherein the training electron microscope images are SEM images of the plurality of wafers processed at a second stage subsequent to the first stage.
18. The method of any one of clauses 1-17, wherein at least one of the training electron microscope images corresponds to a second area on a second wafer of the plurality of wafers, the second area being distinct from the first area on the first wafer.
19. The method of any one of clauses 1-18, further comprising:
   obtaining a plurality of input electron microscope images of a plurality of areas on the first wafer;
   determining, for a respective input electron microscope image, a multi-dimensional vector characterizing the plurality of interpretable modes and associated contributions from the plurality of interpretable modes to the respective input electron microscope image; and
   clustering a plurality of multi-dimensional vectors corresponding to the plurality of input electron microscope images of the first wafer.
20. The method of clause 19, further comprising:
   determining one or more defects associated with a plurality of clusters based on results of the clustering.
21. The method of any one of clauses 19-20, further comprising:
   determining causes of failures based on results of the clustering.
22. The method of clause 21, wherein determining causes of failures based on the results of the clustering further comprises:
   mapping locations of a group of areas corresponding to a cluster of vectors on the first wafer; and
   determining a cause of failure based on the locations of the group of areas on the first wafer and the defects associated with the cluster.
23. The method of any one of clauses 19-22, further comprising:
   receiving a user selection of a region of the first wafer; and
   generating a visualization of defects determined in the region on the first wafer.
24. The method of any one of clauses 19-23, further comprising:
   receiving a user selection of a type of defect; and
   generating a visualization of distribution of areas on the first wafer determined to have the type of defect.
25. The method of any one of clauses 19-24, further comprising:
   obtaining a plurality of input electron microscope images of a plurality of areas on a plurality of wafers including the first wafer in a group;
   determining, for a respective input electron microscope image, a multi-dimensional vector characterizing the plurality of interpretable modes and associated contributions from the plurality of interpretable modes to the respective input electron microscope image;
   clustering a plurality of multi-dimensional vectors corresponding to the plurality of input electron microscope images of the plurality of wafers in the group; and
   determining causes of failures based on results of the clustering.
26. The method of clause 25, further comprising:
   determining one or more defects associated with a plurality of clusters based on the results of the clustering.
27. The method of any one of clauses 25-26, further comprising:
   predicting one or more defects on a second wafer in the group.
28. An apparatus for analyzing an input electron microscope image of a first area on a first wafer, comprising:
   a memory storing a set of instructions; and
   at least one processor configured to execute the set of instructions to cause the apparatus to perform:
      obtaining a plurality of mode images from the input electron microscope image corresponding to a plurality of interpretable modes;
      evaluating the plurality of mode images;
      determining, based on evaluation results, contributions from the plurality of interpretable modes to the input electron microscope image; and
      predicting one or more characteristics in the first area on the first wafer based on the determined contributions.
29. The apparatus of clause 28, wherein a respective interpretable mode of the plurality of interpretable modes is associated with a characteristic of the first area on the first wafer.
30. The apparatus of any one of clauses 28-29, wherein obtaining the plurality of mode images comprises:
   decomposing the input electron microscope image into the plurality of mode images.
31. The apparatus of any one of clauses 28-30, wherein obtaining the plurality of mode images comprises:
   obtaining coefficients associated with the plurality of interpretable modes respectively corresponding to the input electron microscope image.
32. The apparatus of any one of clauses 28-31, wherein the one or more characteristics correspond to one or more categories of defects respectively.
33. The apparatus of any one of clauses 28-32, wherein the one or more categories of defects comprise small critical dimension (CD), shift along a certain direction, ellipticity, blurry edges, printed contact hole, missing contact hole, or bridging contact hole.
34. The apparatus of any one of clauses 28-33, wherein evaluating the plurality of mode images comprises:
   applying a classifier model to the coefficients associated with the plurality of interpretable modes respectively to obtain output including the evaluation results.
35. The apparatus of any one of clauses 28-34, wherein the classifier model is a logistic regression, a support vector machine, or a neural network model.
36. The apparatus of any one of clauses 28-35, wherein evaluating the plurality of mode images comprises:
   obtaining the evaluation results each of which indicates a likelihood of existence of corresponding interpretable modes.
37. The apparatus of any one of clauses 28-36, wherein determining the contributions from the plurality of interpretable modes to the input electron microscope image comprises:
   approximating the classifier model using a polynomial regression model.
38. The apparatus of any one of clauses 28-37, wherein the polynomial regression model includes a linear model.
39. The apparatus of any one of clauses 28-38, wherein determining the contributions from the plurality of interpretable modes to the input electron microscope image comprises:
   determining, from a linear approximation using the linear model, weights associated with the plurality of interpretable modes, respectively.
40. The apparatus of any one of clauses 28-39, wherein the at least one processor is configured to execute the set of instructions to cause the apparatus to further perform:
   generating a visualization representing the contributions from the plurality of interpretable modes to the input electron microscope image.
41. The apparatus of any one of clauses 28-40, wherein the at least one processor is configured to execute the set of instructions to cause the apparatus to further perform:
   adjusting one or more processing parameters in accordance with the one or more characteristics in the area on the wafer.
42. The apparatus of any one of clauses 28-41, wherein the at least one processor is configured to execute the set of instructions to cause the apparatus to further perform:
   determining defect causes based on the determined contributions from the plurality of interpretable modes.
43. The apparatus of any one of clauses 28-42, wherein the at least one processor is configured to execute the set of instructions to cause the apparatus to further perform:
   training the classifier model based on (1) training electron microscope images of a plurality of wafers and (2) label data of the training electron microscope images corresponding to coefficients of a plurality of interpretable modes associated with each of the training electron microscope images.
44. The apparatus of any one of clauses 28-43, wherein the input electron microscope image is a scanning electron microscope (SEM) image of the first area on the first wafer that has been processed at a first stage prior to the first stage, and wherein the training electron microscope images are SEM images of the plurality of wafers processed at a second stage subsequent to the first stage.
45. The apparatus of any one of clauses 28-44, wherein at least one of the training electron microscope images corresponds to a second area on a second wafer of the plurality of wafers, the second area being distinct from the first area on the first wafer.
46. The apparatus of any one of clauses 28-45, wherein the at least one processor is configured to execute the set of instructions to cause the apparatus to further perform:
   obtaining a plurality of input electron microscope images of a plurality of areas on the first wafer;
   determining, for a respective input electron microscope image, a multi-dimensional vector characterizing the plurality of interpretable modes and associated contributions from the plurality of interpretable modes to the respective input electron microscope image; and
   clustering a plurality of multi-dimensional vectors corresponding to the plurality of input electron microscope images of the first wafer.
47. The apparatus of clause 46, wherein the at least one processor is configured to execute the set of instructions to cause the apparatus to further perform:
   determining one or more defects associated with a plurality of clusters based on results of the clustering.
48. The apparatus of any one of clauses 46-47, wherein the at least one processor is configured to execute the set of instructions to cause the apparatus to further perform:
   determining causes of failures based on results of the clustering.
49. The apparatus of clause 48, wherein determining causes of failures based on the results of the clustering further comprises:
   mapping locations of a group of areas corresponding to a cluster of vectors on the first wafer; and
   determining a cause of failure based on the locations of the group of areas on the first wafer and the defects associated with the cluster.
50. The apparatus of any one of clauses 46-49, wherein the at least one processor is configured to execute the set of instructions to cause the apparatus to further perform:
   receiving a user selection of a region of the first wafer; and
   generating a visualization of defects determined in the region on the first wafer.
51. The apparatus of any one of clauses 46-50, wherein the at least one processor is configured to execute the set of instructions to cause the apparatus to further perform:
   receiving a user selection of a type of defect; and
   generating a visualization of distribution of areas on the first wafer determined to have the type of defect.
52. The apparatus of any one of clauses 46-51, wherein the at least one processor is configured to execute the set of instructions to cause the apparatus to further perform:
   obtaining a plurality of input electron microscope images of a plurality of areas on a plurality of wafers including the first wafer in a group;
   determining, for a respective input electron microscope image, a multi-dimensional vector characterizing the plurality of interpretable modes and associated contributions from the plurality of interpretable modes to the respective input electron microscope image;
   clustering a plurality of multi-dimensional vectors corresponding to the plurality of input electron microscope images of the plurality of wafers in the group; and
   determining causes of failures based on results of the clustering.
53. The apparatus of clause 52, wherein the at least one processor is configured to execute the set of instructions to cause the apparatus to further perform:
   determining one or more defects associated with a plurality of clusters based on the results of the clustering.
54. The apparatus of any one of clauses 52-53, wherein the at least one processor is configured to execute the set of instructions to cause the apparatus to further perform:
   predicting one or more defects on a second wafer in the group.
55. A non-transitory computer readable medium that stores a set of instructions that is executable by at least one processor of a computing device to cause the computing device to perform a method of analyzing an input electron microscope image of a first area on a first wafer, the method comprising:
   obtaining a plurality of mode images from the input electron microscope image corresponding to a plurality of interpretable modes;
   evaluating the plurality of mode images;
   determining, based on evaluation results, contributions from the plurality of interpretable modes to the input electron microscope image; and
   predicting one or more characteristics in the first area on the first wafer based on the determined contributions.
56. The non-transitory computer readable medium of clause 55, wherein a respective interpretable mode of the plurality of interpretable modes is associated with a characteristic of the first area on the first wafer.
57. The non-transitory computer readable medium of any one of clauses 55-56, wherein obtaining the plurality of mode images comprises:
   decomposing the input electron microscope image into the plurality of mode images.
58. The non-transitory computer readable medium of any one of clauses 55-57, wherein obtaining the plurality of mode images comprises:
   obtaining coefficients associated with the plurality of interpretable modes respectively corresponding to the input electron microscope image.
59. The non-transitory computer readable medium of any one of clauses 55-58, wherein the one or more characteristics correspond to one or more categories of defects respectively.
60. The non-transitory computer readable medium of any one of clauses 55-59, wherein the one or more categories of defects comprise small critical dimension (CD), shift along a certain direction, ellipticity, blurry edges, printed contact hole, missing contact hole, or bridging contact hole.
61. The non-transitory computer readable medium of any one of clauses 55-60, wherein evaluating the plurality of mode images comprises:
   applying a classifier model to the coefficients associated with the plurality of interpretable modes respectively to obtain output including the evaluation results.
62. The non-transitory computer readable medium of any one of clauses 55-61, wherein the classifier model is a logistic regression, a support vector machine, or a neural network model.
63. The non-transitory computer readable medium of any one of clauses 55-62, wherein evaluating the plurality of mode images comprises:
   obtaining the evaluation results each of which indicates a likelihood of existence of corresponding interpretable modes.
64. The non-transitory computer readable medium of any one of clauses 55-63, wherein
   determining the contributions from the plurality of interpretable modes to the input electron microscope image comprises:
   approximating the classifier model using a polynomial regression model.
65. The non-transitory computer readable medium of any one of clauses 55-64, wherein the polynomial regression model includes a linear model.
66. The non-transitory computer readable medium of any one of clauses 55-65, wherein determining the contributions from the plurality of interpretable modes to the input electron microscope image comprises:
   determining, from a linear approximation using the linear model, weights associated with the plurality of interpretable modes, respectively.
67. The non-transitory computer readable medium of any one of clauses 55-66, wherein the set of instructions that is executable by at least one processor of the computing device to cause the computing device to further perform:
   generating a visualization representing the contributions from the plurality of interpretable modes to the input electron microscope image.
68. The non-transitory computer readable medium of any one of clauses 55-67, wherein the set of instructions that is executable by at least one processor of the computing device to cause the computing device to further perform:
   adjusting one or more processing parameters in accordance with the one or more characteristics in the area on the wafer.
69. The non-transitory computer readable medium of any one of clauses 55-68, wherein the set of instructions that is executable by at least one processor of the computing device to cause the computing device to further perform:
   determining defect causes based on the determined contributions from the plurality of interpretable modes.
70. The non-transitory computer readable medium of any one of clauses 55-69, wherein the set of instructions that is executable by at least one processor of the computing device to cause the computing device to further perform, further comprising:
   training the classifier model based on (1) training electron microscope images of a plurality of wafers and (2) label data of the training electron microscope images corresponding to coefficients of a plurality of interpretable modes associated with each of the training electron microscope images.
71. The non-transitory computer readable medium of any one of clauses 55-70, wherein the input electron microscope image is a scanning electron microscope (SEM) image of the first area on the first wafer that has been processed at a first stage prior to the first stage, and wherein the training electron microscope images are SEM images of the plurality of wafers processed at a second stage subsequent to the first stage.
72. The non-transitory computer readable medium of any one of clauses 55-71, wherein at least one of the training electron microscope images corresponds to a second area on a second wafer of the plurality of wafers, the second area being distinct from the first area on the first wafer.
73. The non-transitory computer readable medium of any one of clauses 55-72, wherein the set of instructions that is executable by at least one processor of the computing device to cause the computing device to further perform:
   obtaining a plurality of input electron microscope images of a plurality of areas on the first wafer;
   determining, for a respective input electron microscope image, a multi-dimensional vector characterizing the plurality of interpretable modes and associated contributions from the plurality of interpretable modes to the respective input electron microscope image; and
   clustering a plurality of multi-dimensional vectors corresponding to the plurality of input electron microscope images of the first wafer.
74. The non-transitory computer readable medium of clause 73, wherein the set of instructions that is executable by at least one processor of the computing device to cause the computing device to further perform:
   determining one or more defects associated with a plurality of clusters based on results of the clustering.
75. The non-transitory computer readable medium of any one of clauses 73-74, wherein the set of instructions that is executable by at least one processor of the computing device to cause the computing device to further perform:
   determining causes of failures based on results of the clustering.
76. The non-transitory computer readable medium of clause 75, wherein determining causes of failures based on the results of the clustering further comprises:
   mapping locations of a group of areas corresponding to a cluster of vectors on the first wafer; and
   determining a cause of failure based on the locations of the group of areas on the first wafer and the defects associated with the cluster.
77. The non-transitory computer readable medium of any one of clauses 73-76, wherein the set of instructions that is executable by at least one processor of the computing device to cause the computing device to further perform:
   receiving a user selection of a region of the first wafer; and
   generating a visualization of defects determined in the region on the first wafer.
78. The non-transitory computer readable medium of any one of clauses 73-77, wherein the set of instructions that is executable by at least one processor of the computing device to cause the computing device to further perform:
   receiving a user selection of a type of defect; and
   generating a visualization of distribution of areas on the first wafer determined to have the type of defect.
79. The non-transitory computer readable medium of any one of clauses 73-78, wherein the set of instructions that is executable by at least one processor of the computing device to cause the computing device to further perform:
   obtaining a plurality of input electron microscope images of a plurality of areas on a plurality of wafers including the first wafer in a group;
   determining, for a respective input electron microscope image, a multi-dimensional vector characterizing the plurality of interpretable modes and associated contributions from the plurality of interpretable modes to the respective input electron microscope image;
   clustering a plurality of multi-dimensional vectors corresponding to the plurality of input electron microscope images of the plurality of wafers in the group; and
   determining causes of failures based on results of the clustering.
80. The non-transitory computer readable medium of clause 79, wherein the set of instructions that is executable by at least one processor of the computing device to cause the computing device to further perform:
   determining one or more defects associated with a plurality of clusters based on the results of the clustering.
81. The non-transitory computer readable medium of any one of clauses 79-80, wherein the set of instructions that is executable by at least one processor of the computing device to cause the computing device to further perform:
   predicting one or more defects on a second wafer in the group.
82. A method of training a classifier model for classifying electron microscope images, the method comprising:
   obtaining training electron microscope images of a plurality of wafers;
   obtaining label data of the training electron microscope images indicating a plurality of interpretable modes associated with each of the training electron microscope images; and
   training the classifier model based on the training electron microscope images and the label data.
83. The method of clause 82, wherein the plurality of interpretable modes correspond to a plurality of categories of defects respectively.
84. The method of any one of clauses 82-83, wherein the classifier model is a logistic regression, a support vector machine, or a neural network model.
85. The method of any one of clauses 82-84, wherein the training electron microscope images are scanning electron microscope (SEM) images of the plurality of wafers.
86. The method of any one of clauses 82-85, wherein the label data is obtained by an automatic program including principal component analysis (PCA) or singular value decomposition (SVD).
87. An apparatus for training a classifier model for classifying electron microscope images, the apparatus comprising:
   a memory storing a set of instructions; and
   at least one processor configured to execute the set of instructions to cause the apparatus to perform:
      obtaining training electron microscope images of a plurality of wafers;
      obtaining label data of the training electron microscope images indicating a plurality of interpretable modes associated with each of the training electron microscope images; and
      training the classifier model based on the training electron microscope images and the label data.
88. The apparatus of clause 87, wherein the plurality of interpretable modes correspond to a plurality of categories of defects respectively.
89. The apparatus of any one of clauses 87-88, wherein the classifier model is a logistic regression, a support vector machine, or a neural network model.
90. The apparatus of any one of clauses 87-89, wherein the training electron microscope images are scanning electron microscope (SEM) images of the plurality of wafers.
91. The apparatus of any one of clauses 87-90, wherein the label data is obtained by an automatic program including principal component analysis (PCA) or singular value decomposition (SVD).
92. A non-transitory computer readable medium that stores a set of instructions that is executable by at least one processor of a computing device to cause the computing device to perform a method of training a classifier model for classifying electron microscope images, the method comprising:
   obtaining training electron microscope images of a plurality of wafers;
   obtaining label data of the training electron microscope images indicating a plurality of interpretable modes associated with each of the training electron microscope images; and
   training the classifier model based on the training electron microscope images and the label data.
93. The non-transitory computer readable medium of clause 92, wherein the plurality of interpretable modes correspond to a plurality of categories of defects respectively.
94. The non-transitory computer readable medium of any one of clauses 92-93, wherein the classifier model is a logistic regression, a support vector machine, or a neural network model.
95. The non-transitory computer readable medium of any one of clauses 92-94, wherein the training electron microscope images are scanning electron microscope (SEM) images of the plurality of wafers.
96. The non-transitory computer readable medium of any one of clauses 92-95, wherein the label data is obtained by an automatic program including principal component analysis (PCA) or singular value decomposition (SVD).
97. A method for an automatic root cause analysis based on an input electron microscope image of a wafer, the method comprising:
   obtaining input data associated with the input electron microscope image, the input data including a plurality of process features of the wafer;
   identifying a set of process features from the plurality of process features by applying a plurality of pre-trained decision tree models to the plurality of process features; and
   outputting a ranking result of the set of process features.
98. The method of clause 97, wherein the plurality of process features include lithography parameters, etching parameters, or inspection parameters associated with processing the wafer.
99. The method of any one of clauses 97-98, further comprising:
   training the plurality of decision tree models based on image data of a plurality of electron microscope images of a plurality of wafers, process data associated with processing the plurality of wafers, and label data indicating defect information associated with each of the electron microscope images.
100. The method of any one of clauses 97-99, wherein the plurality of pre-trained decision tree models are part of a random forest model, an XGBoost model, or a decision tree classification model.
101. The method of any one of clauses 97-100, wherein the plurality of pre-trained decision tree models are decorrelated, and the set of process features are identified based on averaging results from applying the plurality of pre-trained decision tree models to the plurality of process features.
102. The method of any one of clauses 97-101, further comprising outputting a defect prediction result associated with types or locations of one or more defects to be formed on the wafer.
103. The method of any one of clauses 97-102, further comprising causing an inspection system to inspect an area on the wafer corresponding to the outputted defect prediction result.
104. An apparatus for an automatic root cause analysis based on an input electron microscope image of a wafer, comprising:
   a memory storing a set of instructions; and
   at least one processor configured to execute the set of instructions to cause the apparatus to perform:
      obtaining input data associated with the input electron microscope image, the input data including a plurality of process features of the wafer;
      identifying a set of process features from the plurality of process features by applying a plurality of pre-trained decision tree models to the plurality of process features; and
      outputting a ranking result of the set of process features.
105. The apparatus of clause 104, wherein the plurality of process features include lithography parameters, etching parameters, or inspection parameters associated with processing the wafer.
106. The apparatus of any one of claims 104-105, wherein the at least one processor is configured to execute the set of instructions to cause the apparatus to further perform:
   training the plurality of decision tree models based on image data of a plurality of electron microscope images of a plurality of wafers, process data associated with processing the plurality of wafers, and label data indicating defect information associated with each of the electron microscope images.
107. The apparatus of any one of clauses 104-106, wherein the plurality of pre-trained decision tree models are part of a random forest model, an XGBoost model, or a decision tree classification model.
108. The apparatus of any one of clauses 104-107, wherein the plurality of pre-trained decision tree models are decorrelated, and the set of process features are identified based on averaging results from applying the plurality of pre-trained decision tree models to the plurality of process features.
109. The apparatus of any one of clauses 104-108, wherein the at least one processor is configured to execute the set of instructions to cause the apparatus to further perform:
   outputting a defect prediction result associated with types or locations of one or more defects to be formed on the wafer.
110. The apparatus of any one of clauses 104-109, wherein the at least one processor is configured to execute the set of instructions to cause the apparatus to further perform:
   causing an inspection system to inspect an area on the wafer corresponding to the outputted defect prediction result.
111. A non-transitory computer readable medium that stores a set of instructions that is executable by at least one processor of a computing device to cause the computing device to perform a method for an automatic root cause analysis based on an input electron microscope image of a wafer, the method comprising:
   obtaining input data associated with the input electron microscope image, the input data including a plurality of process features of the wafer;
   identifying a set of process features from the plurality of process features by applying a plurality of pre-trained decision tree models to the plurality of process features; and
   outputting a ranking result of the set of process features.
112. The non-transitory computer readable medium of clause 111, wherein the plurality of process features include lithography parameters, etching parameters, or inspection parameters associated with processing the wafer.
113. The non-transitory computer readable medium of any one of clauses 111-112, wherein the set of instructions that is executable by at least one processor of the computing device to cause the computing device to further perform:
   training the plurality of decision tree models based on image data of a plurality of electron microscope images of a plurality of wafers, process data associated with processing the plurality of wafers, and label data indicating defect information associated with each of the electron microscope images.
114. The non-transitory computer readable medium of any of clauses 111-113, wherein the plurality of pre-trained decision tree models are part of a random forest model, an XGBoost model, or a decision tree classification model.
115. The non-transitory computer readable medium of any of clauses 111-114, wherein the plurality of pre-trained decision tree models are decorrelated, and the set of process features are identified based on averaging results from applying the plurality of pre-trained decision tree models to the plurality of process features.
116. The non-transitory computer readable medium of any of clauses 111-115, wherein the set of instructions that is executable by at least one processor of the computing device to cause the computing device to further perform:
   outputting a defect prediction result associated with types or locations of one or more defects to be formed on the wafer.
117. The non-transitory computer readable medium of any of clauses 111-116, wherein the set of instructions that is executable by at least one processor of the computing device to cause the computing device to further perform:
   causing an inspection system to inspect an area on the wafer corresponding to the outputted defect prediction result.

It will be appreciated that the embodiments of the present disclosure are not limited to the exact construction that has been described above and illustrated in the accompanying drawings, and that various modifications and changes may be made without departing from the scope thereof. The present disclosure has been described in connection with various embodiments, other embodiments of the invention will be apparent to those skilled in the art from consideration of the specification and practice of the invention disclosed herein. It is intended that the specification and examples be considered as exemplary only, with a true scope and spirit of the invention being indicated by the following claims.

The descriptions above are intended to be illustrative, not limiting. Thus, it will be apparent to one skilled in the art that modifications may be made as described without departing from the scope of the claims set out below.

1. An apparatus for analyzing an input electron microscope image of a first area on a first wafer, comprising:
a memory storing a set of instructions; and
at least one processor configured to execute the set of instructions to cause the apparatus to perform:
obtaining a plurality of mode images from the input electron microscope image corresponding to a plurality of interpretable modes;
evaluating the plurality of mode images;
determining, based on evaluation results, contributions from the plurality of interpretable modes to the input electron microscope image; and
predicting one or more characteristics in the first area on the first wafer based on the determined contributions.

2. The apparatus of claim 1, wherein a respective interpretable mode of the plurality of interpretable modes is associated with a characteristic of the first area on the first wafer.

3. The apparatus of claim 1, wherein obtaining the plurality of mode images comprises:
decomposing the input electron microscope image into the plurality of mode images.

4. The apparatus of claim 1, wherein obtaining the plurality of mode images comprises:
obtaining coefficients associated with the plurality of interpretable modes respectively corresponding to the input electron microscope image.

5. The apparatus of claim 1, wherein the one or more characteristics correspond to one or more categories of defects respectively.

6. The apparatus of claim 1, wherein the one or more categories of defects comprise small critical dimension (CD), shift along a certain direction, ellipticity, blurry edges, printed contact hole, missing contact hole, or bridging contact hole.

7. The apparatus of claim 1, wherein evaluating the plurality of mode images comprises:
applying a classifier model to the coefficients associated with the plurality of interpretable modes respectively to obtain output including the evaluation results.

8. The apparatus of claim 7, wherein the classifier model is a logistic regression, a support vector machine, or a neural network model.

9. The apparatus of claim 1, wherein evaluating the plurality of mode images comprises:
obtaining the evaluation results each of which indicates a likelihood of existence of corresponding interpretable modes.

10. The apparatus of claim 1, wherein determining the contributions from the plurality of interpretable modes to the input electron microscope image comprises:
approximating the classifier model using a polynomial regression model.

11. The apparatus of claim 10, wherein the polynomial regression model includes a linear model.

12. The apparatus of claim 1, wherein determining the contributions from the plurality of interpretable modes to the input electron microscope image comprises:
determining, from a linear approximation using the linear model, weights associated with the plurality of interpretable modes, respectively.

13. The apparatus of claim 1, wherein the at least one processor is configured to execute the set of instructions to cause the apparatus to further perform:
generating a visualization representing the contributions from the plurality of interpretable modes to the input electron microscope image.

14. The apparatus of claim 1, wherein the at least one processor is configured to execute the set of instructions to cause the apparatus to further perform:
adjusting one or more processing parameters in accordance with the one or more characteristics in the area on the wafer.

15. The apparatus of claim 1, wherein the at least one processor is configured to execute the set of instructions to cause the apparatus to further perform:
determining defect causes based on the determined contributions from the plurality of interpretable modes.

16. A non-transitory computer readable medium that stores a set of instructions that is executable by at least one processor of a computing device to cause the computing device to perform operations for analyzing an input electron microscope image of a first area on a first wafer, the operations comprising:
obtaining a plurality of mode images from the input electron microscope image corresponding to a plurality of interpretable modes;
evaluating the plurality of mode images;
determining, based on evaluation results, contributions from the plurality of interpretable modes to the input electron microscope image; and
predicting one or more characteristics in the first area on the first wafer based on the determined contributions.

17. The non-transitory computer readable medium of claim 16, wherein a respective interpretable mode of the plurality of interpretable modes is associated with a characteristic of the first area on the first wafer.

18. The non-transitory computer readable medium of claim 16, wherein obtaining the plurality of mode images comprises:
decomposing the input electron microscope image into the plurality of mode images.

19. The non-transitory computer readable medium of claim 16, wherein obtaining the plurality of mode images comprises:
obtaining coefficients associated with the plurality of interpretable modes respectively corresponding to the input electron microscope image.

20. The non-transitory computer readable medium of claim 16, wherein the one or more characteristics correspond to one or more categories of defects respectively.
